(19) United States
(12) Patent Application Publication
(10) Pub. No.: US 2007/0033216 A1
(43) Pub. Date: Feb. 8, 2007

(54) System and method for generating and verifying animal data

(76) Inventors: James F. Heinle, Cranford, NJ (US); Daniel Ellsworth, Stewartsville, NJ (US); Tyler R. Brown, Smithville, MO (US); Richard L. Sibbel, Ankeny, IA (US); Raymond Majewski, Kendall Park, NJ (US)

Correspondence Address: PATENT DOCKET ANDMINSTRATOR;LOWENSTEIN SANDLER PC, 65 LIVINGSTON AVENUE, ROSELAND, NJ, 07068, US

(21) Appl. No.: 11/357,568

(22) Filed: Feb. 17, 2006

Related U.S. Application Data
(63) Continuation-in-part of application No. 11/198,880, filed on Aug. 5, 2005.

(51) Int. Cl. G06F 7/00

(52) U.S. Cl. 707/102; 119/174

(57) ABSTRACT

The present invention provides a system and method for generating animal data and providing certificates on the basis of such data in a network environment. Multiple contributors employ a data upload tool to upload seed data to be placed into a set of target fields of a database to initiate an individualized set for the animal in a network environment. Additionally, an animal husbandry process for the animal is inputted into the database to be added to the individualized data set initiated for the animal such that the individualized data set for the animal is generated in the network environment. The generated individualized data set for the animal is then displayed for verification. The displayed individualized data set is thereafter verified by a contributor independent of the animal ownership. Finally, a certificate that comprises the verified individualized data set and a signature field is issued such that, if signed, the certificate provides the assurance of the verification of the individualized data for the animal.

### CROSS-REFERENCE TO RELATED APPLICATION

This application is a continuation in part of prior U.S. patent application Ser. No. 11/198,880 filed Aug. 5, 2005, currently pending. The entire disclosure of the application Ser. No. 11/198,880 is incorporated herein by reference.

### BACKGROUND OF THE INVENTION

The present invention relates to a system and method for generating and verifying animal data. In particular, the invention relates to providing a tool for generating animal data and providing certificates on the basis of such data in a network environment.

The livestock industry being a representative of the animal industry is constantly evolving and recently began consolidating. Additionally, there are more strict standards being enforced on animal health and the safety of meat products. As a result, the managing and processing of the livestock data needs to be evolved and enhanced to keep up with the industry standards.

Livestock producers, feedlot operators, veterinarians, or other livestock industry participants are required to safely collect, store and manage livestock data such as birth dates, sex, birth type, origin, source, health procedures etc. The goal is to eventually provide a certificate verifying the authenticity of the animal. In order to keep up with the evolving industry, there is a need to provide an enhanced system and method for managing and processing animal data which is secure, less-time consuming and cumbersome. Additionally, there is also a need to provide a simple, quick and safe method for providing certificates of such information by an independent party.

### SUMMARY OF THE INVENTION

The present invention provides a system and method for providing a tool for generating animal data and providing certificates on the basis of such data in a network environment.

According to one embodiment of the present invention, there is provided a method for one or more contributors to generate an individualized data set for an animal in a network environment. The method comprises uploading seed data for an animal employing a data upload tool to place the seed data into a set of target fields of a database to initiate an individualized data set for the animal in a network environment. The method further comprises inputting an animal husbandry process for the animal into the database such that the animal husbandry process is added to the individualized data set initiated for the animal in a network environment, and that the individualized data set for the animal is generated in a network environment.

According to another embodiment of the present invention, there is provided a method for one or more contributors to provide a certificate for animal data in a network environment. The method comprises uploading seed data for an animal employing a data upload tool to place the seed data into a set of target fields of a database to initiate an individualized data set for the animal in a network environment. The method also comprises inputting an animal husbandry process for the animal into the database such that the animal husbandry process is added to the individualized data set initiated for the animal in a network environment and the individualized data set for the animal is generated in a network environment. The method further comprises displaying the generated individualized data set for the animal for verification and verifying the displayed individualized data by a contributor independent of animal ownership. The method finally comprises issuing a certificate that comprises the verified individualized data and a signature field such that, when said signature field is signed, the certificate provides assurance of the verification of the individualized data for said animal.

### BRIEF DESCRIPTION OF THE DRAWINGS

FIG. 1 is a block diagram of the system for generating an individualized data set according to one embodiment of the present invention.

FIG. 2 is a graphical representation of screen display illustrating a login to the website.

FIG. 3 is a graphical representation of screen display illustrating a home page of the secure web site.

FIG. 4 is a graphical representation of screen display when “Operations” item is selected.

FIG. 4A is a graphical representation of screen display when a contributor desire to view operations already in the system.

FIG. 4B is a graphical representation of screen display when a facilitator desire to add operations with fields populated.

FIG. 4C is a graphical representation of screen display after the information on a new operation has been submitted for entry into the database.

FIG. 5 is a graphical representation of screen display when “Contributor” item is selected.

FIG. 5A is a graphical representation of screen display when a contributor desires to view the contributors already in the system.

FIG. 5B is a graphical representation of screen display in order to select the operation for adding users.

FIG. 5C is a graphical representation of screen display when a contributor desires to add other users with fields populated.

FIG. 5D is a graphical representation of screen display after the information on a new has been submitted or entry into the database.

FIG. 6 is a graphical representation of screen display when “Animals” item is selected.

FIG. 6A is a graphical representation of screen display when a contributor activates “Manage Animals” action item on a web page.

FIG. 6B is a graphical representation of screen display of the “Manage Animals” portion relating to the operation name that was chosen.

FIG. 6C is a graphical representation of screen display for manually adding Age/Process animal.

FIG. 6D is a graphical representation of screen display for manually adding Source/Movement animal.

FIG. 6E is a graphical representation of screen display for manually adding both Age/Process and Source/Movement animal.

FIG. 6F is a graphical representation of screen display after the animal has been added to the database.

FIG. 6G is a graphical representation of screen display when a contributor activates “Upload Animals” action item on a web page.

FIG. 6H is a graphical representation of screen display of beginning of mapping interface portion of the upload feature.

FIG. 6I is a graphical representation of screen display of the mapped fields of the upload feature.

FIG. 6J is a graphical representation of screen display of the beginning of the loading process of the upload feature.

FIG. 6K is a graphical representation of screen display of the result of the loading process of the upload feature.

FIG. 6L is a graphical representation of screen display of the animals upload history after the completion of the loading process.

FIG. 6M is a graphical representation of screen display of the animal data being edited which failed during loading process.

FIG. 6N is a graphical representation of screen display of the animals upload history after the edition/correction of the animal data.

FIG. 7 is a graphical representation of screen display when “Process” item is selected.

FIG. 7A is a graphical representation of screen display illustrating a list of available operations for the contributor when a contributor desires to manage process.

FIG. 7B is a graphical representation of screen display listing process for the selected operation.

FIG. 7C is a graphical representation of screen display when a contributor desires to add process with field(s) populated for the selected operation.

FIG. 7D is a graphical representation of screen display illustrating the process created successfully for the selected operation.

FIG. 7E is a graphical representation of screen display when a contributor desires to edit the process.

FIG. 7F is a graphical representation of screen display when a contributor desires to add procedures/products to the process.

FIG. 7G is a graphical representation of screen display upon successful addition of products.

FIG. 7H is a graphical representation of screen display listing of all animals for the selected operation, when a contributor desires to assign process to animals.

FIG. 7I is a graphical representation of screen display illustrating the list of choices of process to assign to the selected animals.

FIG. 7J is a graphical representation of screen display illustrating an updated list of process assigned to the selected animals.

FIG. 7K is a graphical representation of screen display illustrating an example of available process established for a particular operation.

FIG. 8 is a graphical representation of screen display when “Certificates” item is selected.

FIG. 8A is a graphical representation of screen display of a table of incomplete certificates.

FIG. 8B is a graphical representation of screen display of a table of completed certificates.

FIG. 8C is a graphical representation of screen display of different types of certificates that can be created.

FIG. 8D is a graphical representation of screen display at the first stage of certificate issuance.

FIG. 8E is a graphical representation of screen display of preparing the certificate during the first stage.

FIG. 8F is a graphical representation of screen display at the second stage of certificate issuance.

FIG. 8G is a graphical representation of screen display at the third stage of certificate issuance.

FIG. 8H is a graphical representation of screen display at the fourth stage of certificate issuance.

FIG. 8I is a graphical representation of screen display of an updated table of incomplete certificates.

FIG. 8J is a graphical representation of screen display of a preview of a movement certificate for an individual animal.

FIG. 8K is a graphical representation of screen display of preparing a movement certificate for a group of animals.

FIG. 8L is a graphical representation of screen display of a preview of a movement certificate for a group of animals.

FIG. 8M is a graphical representation of screen display of the certificate in final form.

### DETAILED DESCRIPTION OF THE PREFERRED EMBODIMENTS

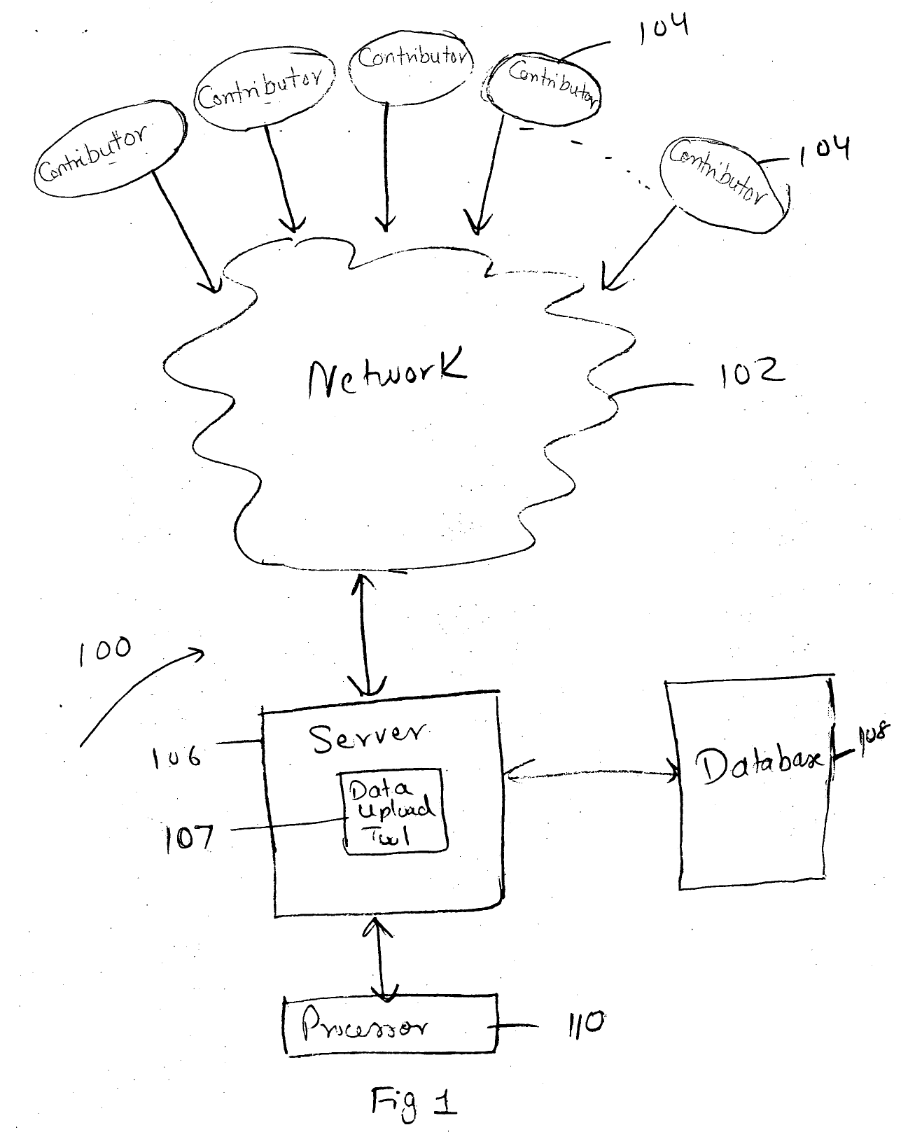

Referring to FIG. 1, there is shown a block diagram of the system 100 for generating an individualized data set for an animal and providing certificates based on such data set, according to one embodiment of the present invention. Shown in the figure is block diagram form is a network 102 which may be a global computer implemented network, such as the Internet, or any other type of network, such as an Intranet, Virtual Private Network (VPN), local area network (LAN), wide area network (WAN), etc. Connected to network 102 via their respective network interface devices is plurality of “contributors” 104, which may be cattle producers, feedlot operators, farm managers, facilitators such as veterinarians or other livestock industry participants with interest in the livestock (e.g. cattle) source, origin and/or health history verification, for example. Contributors 104 who are not facilitators are herein referred to as “users”. Such users include producers, farm managers, feedlot operators or other participants of the livestock industry. “Facilitators” as used herein are preferably veterinarians or any other individual who is independent of the animal ownership such that he/she does not have an ownership interest in either the animals(s) or animal farm/operation, and is also not an employee of the animal owner or animal farm/operation.

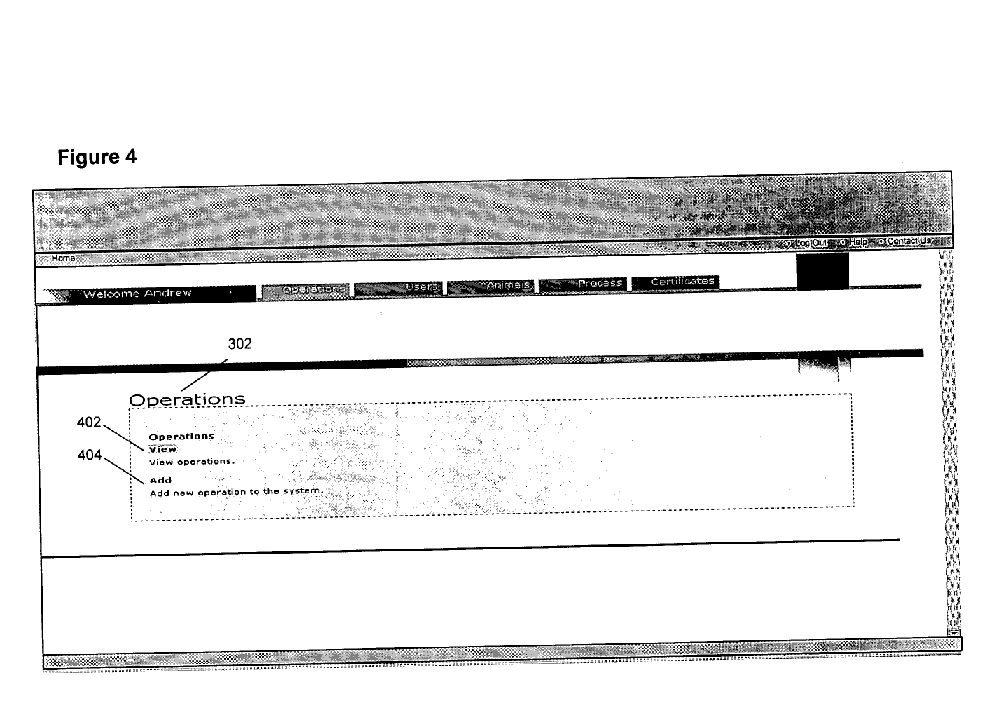

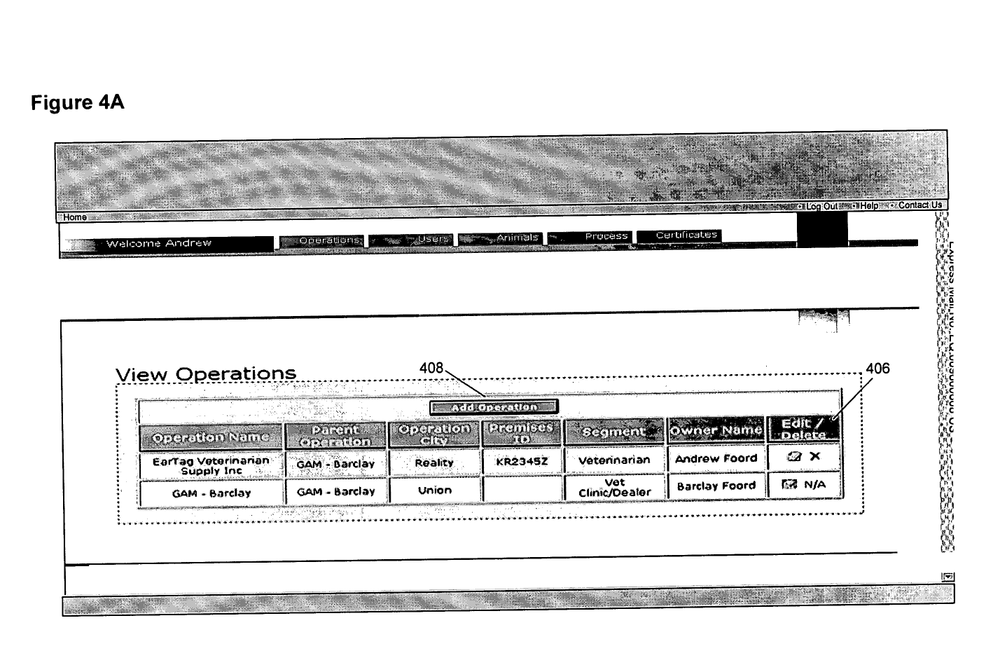

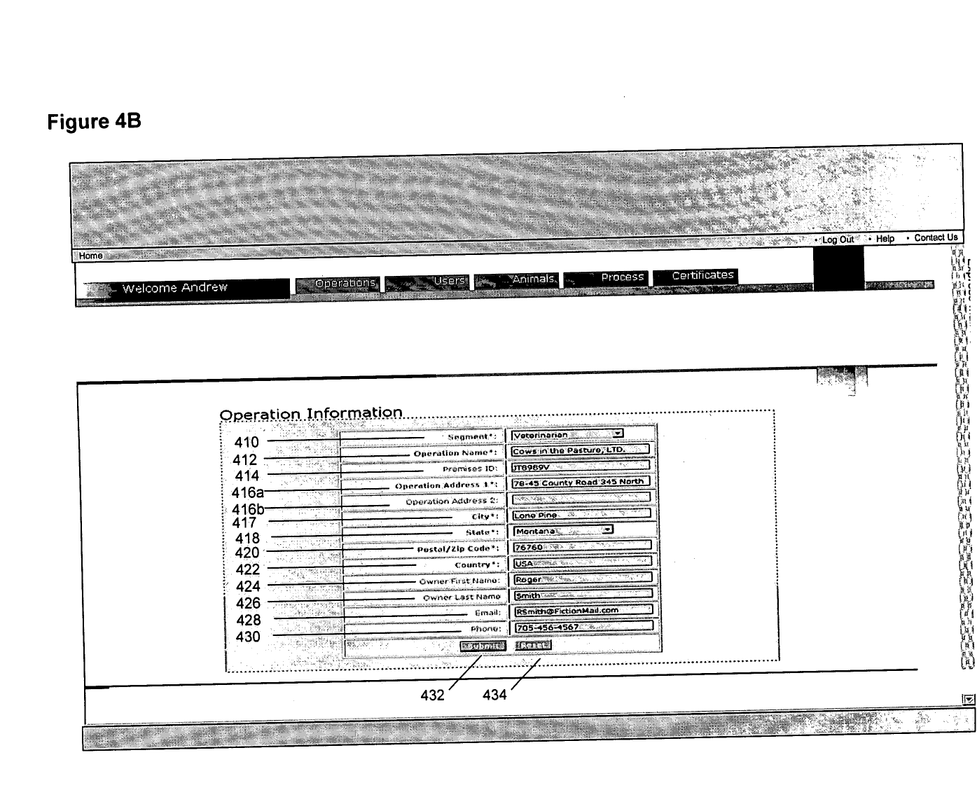

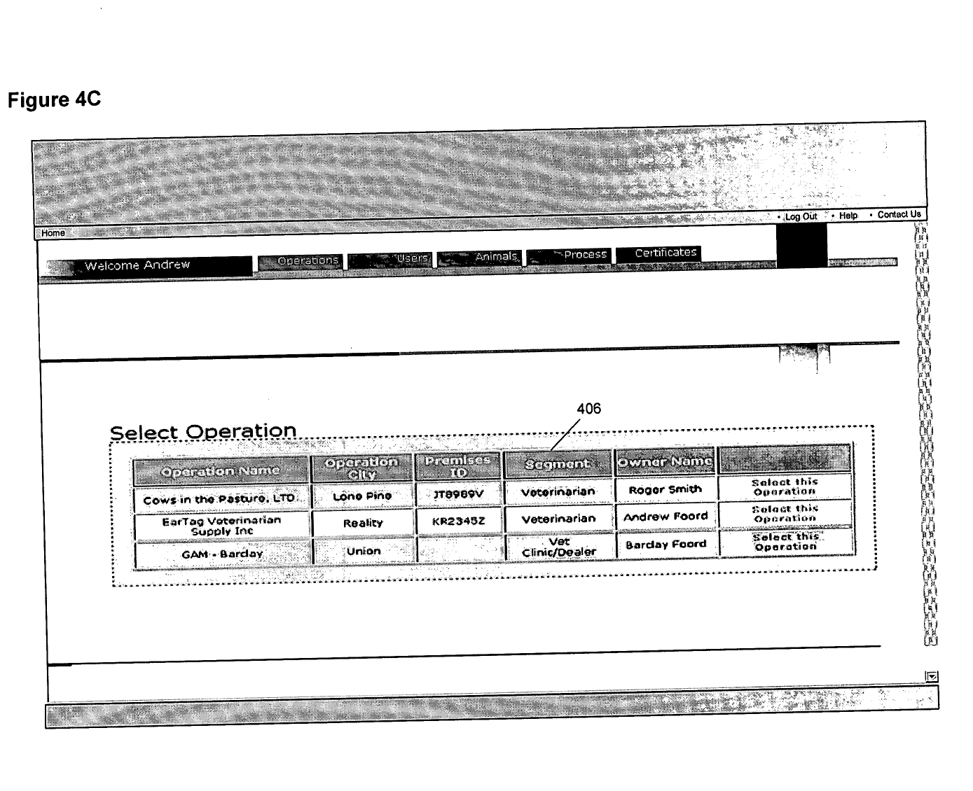

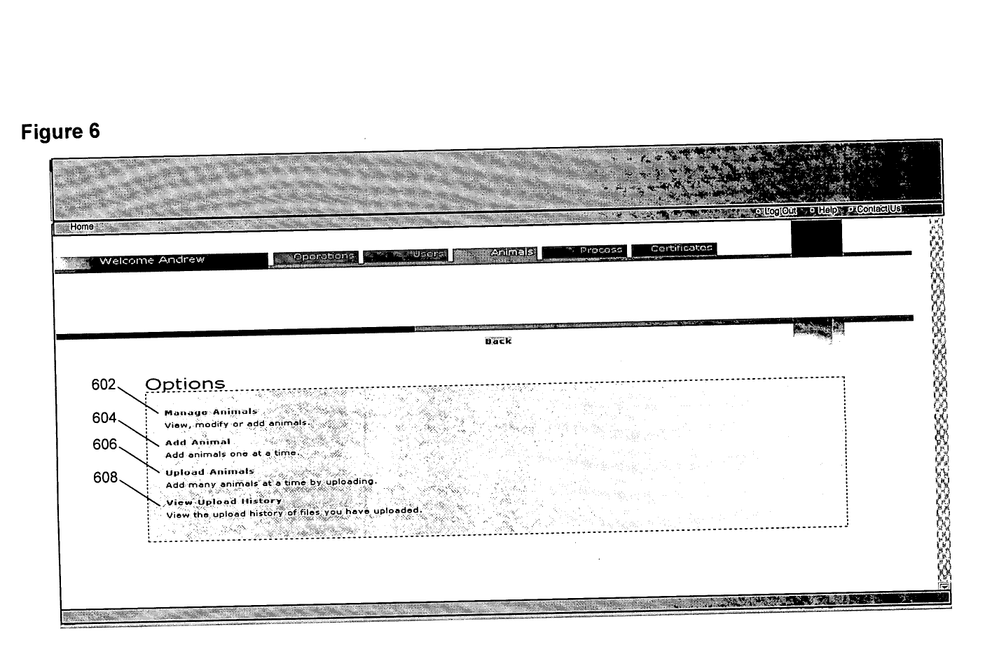

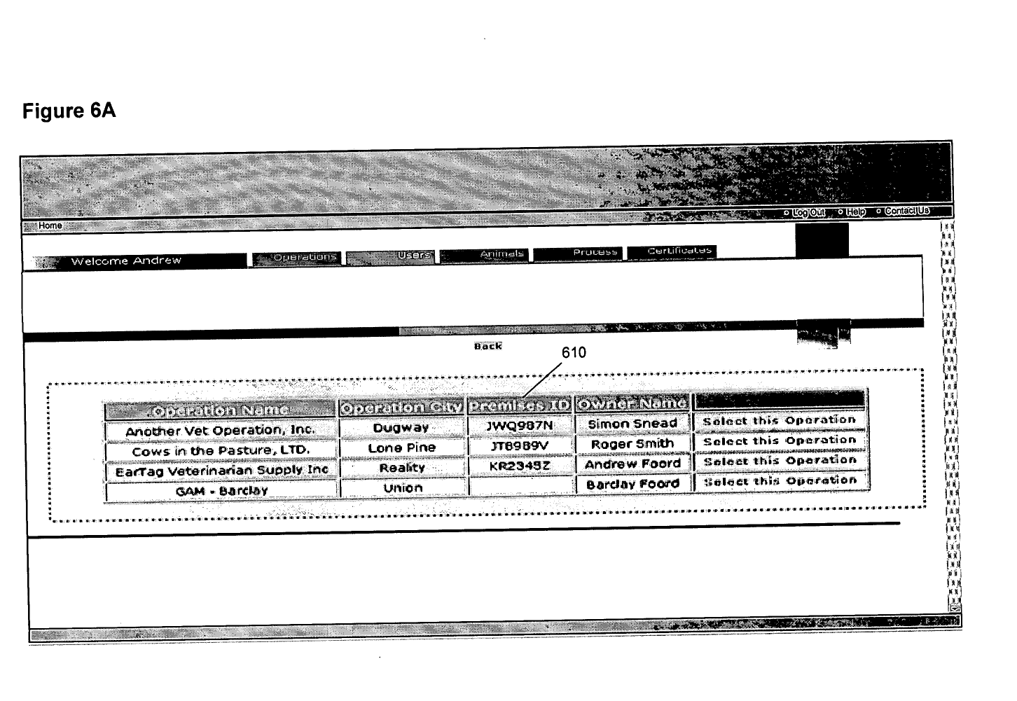

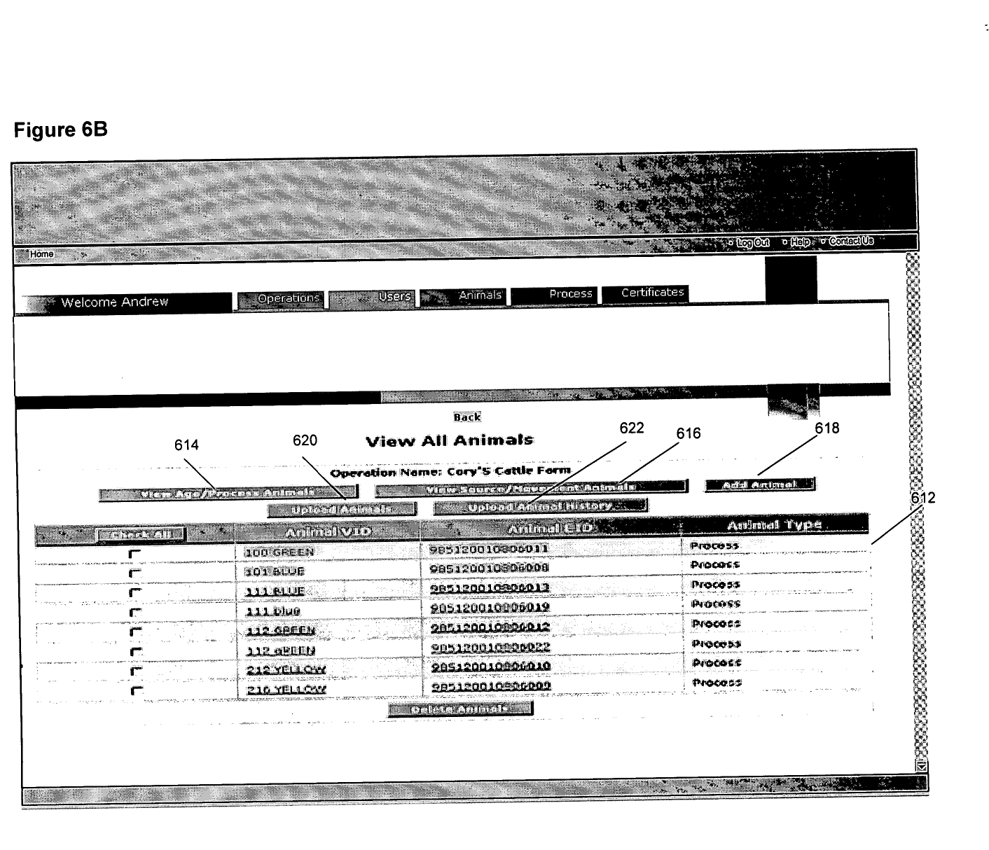

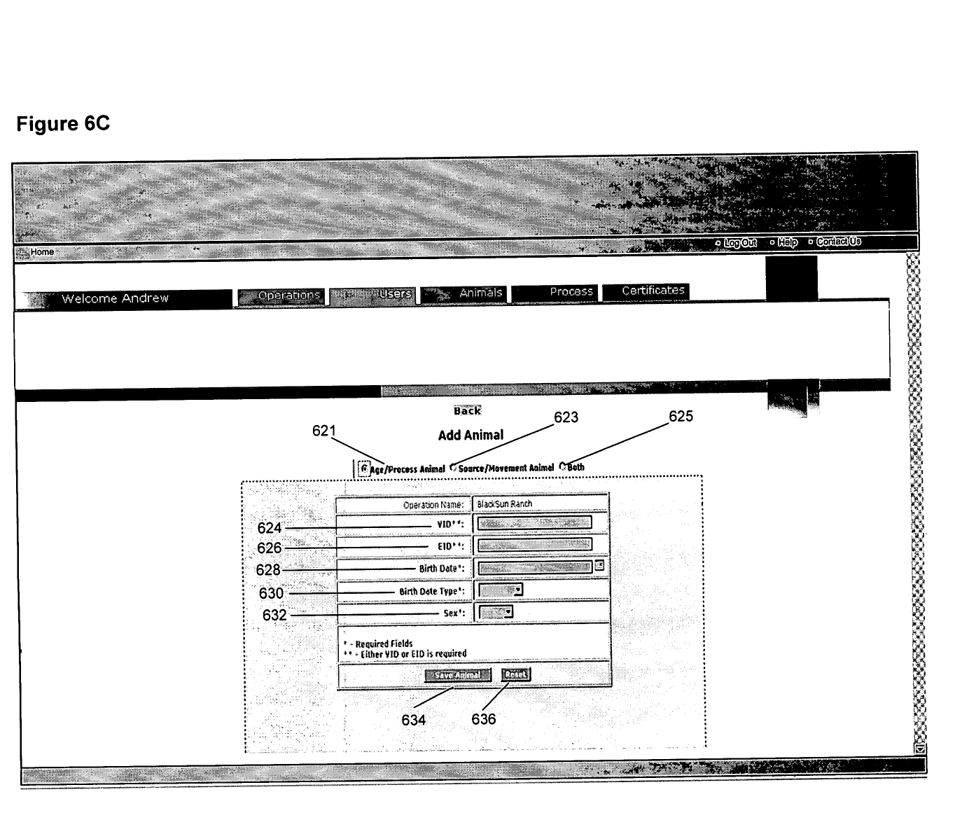

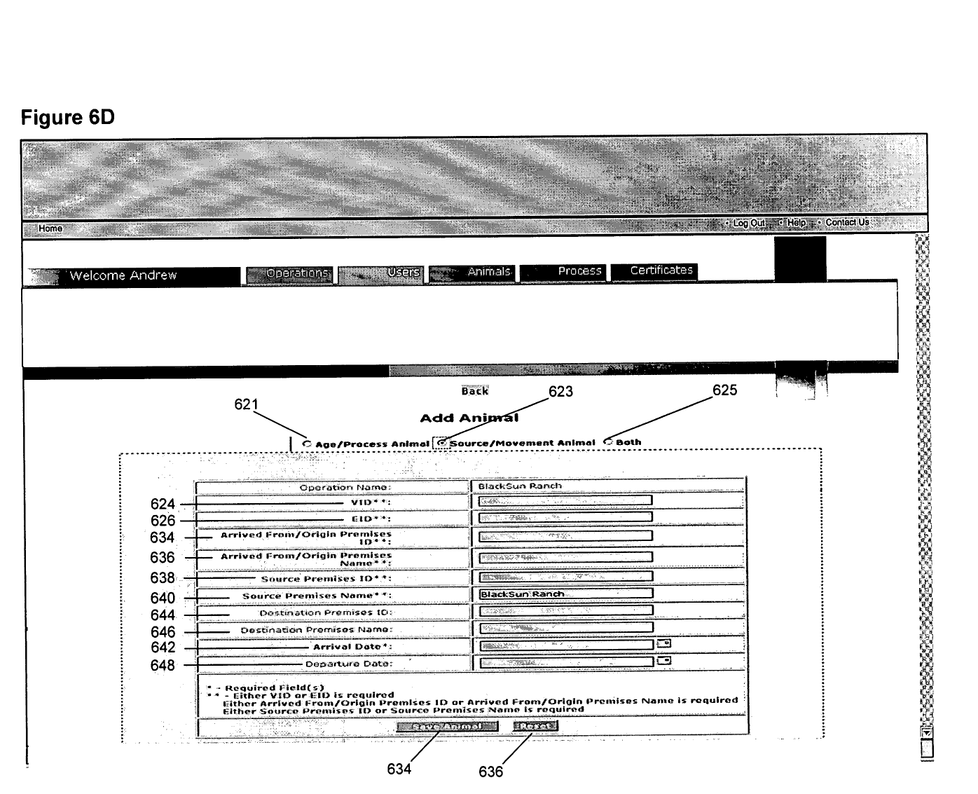

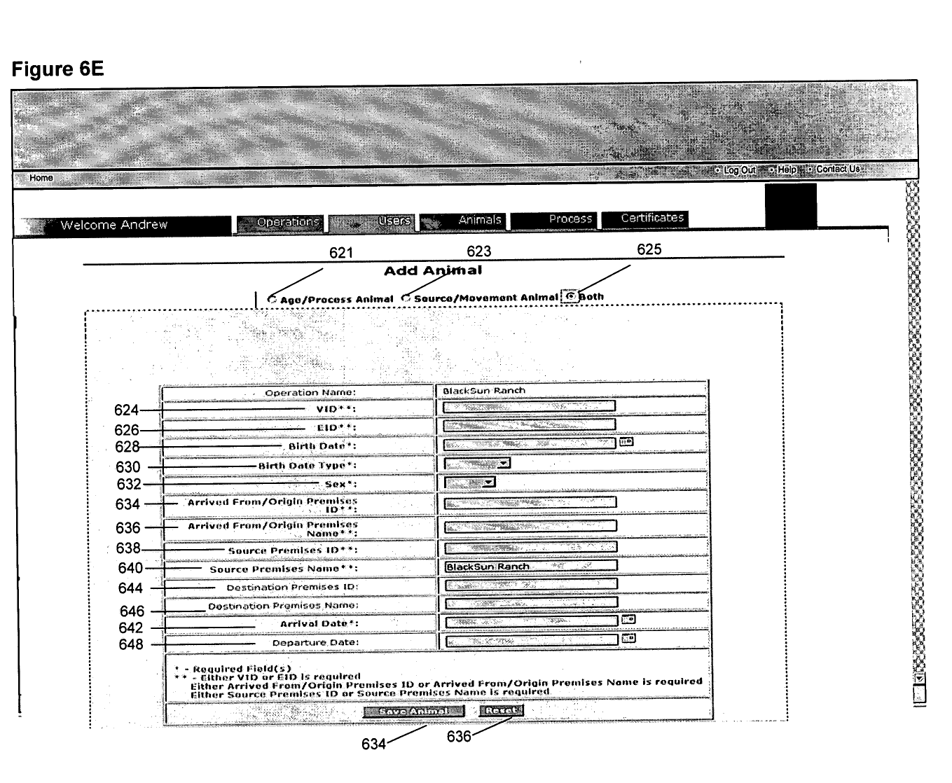

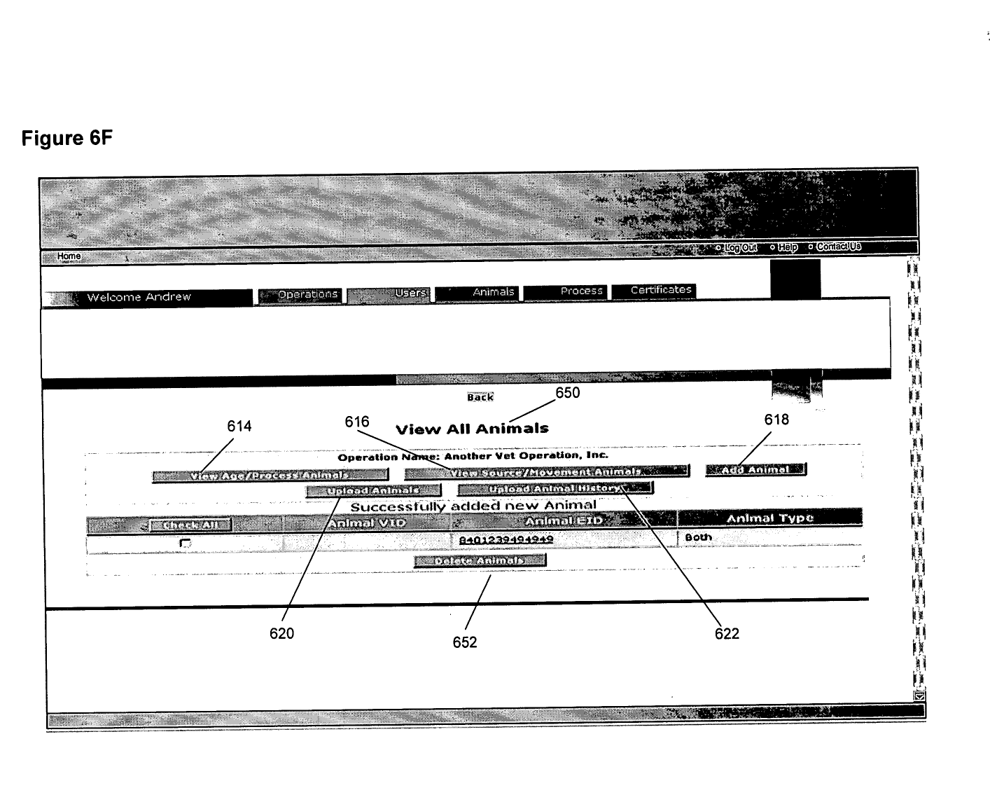

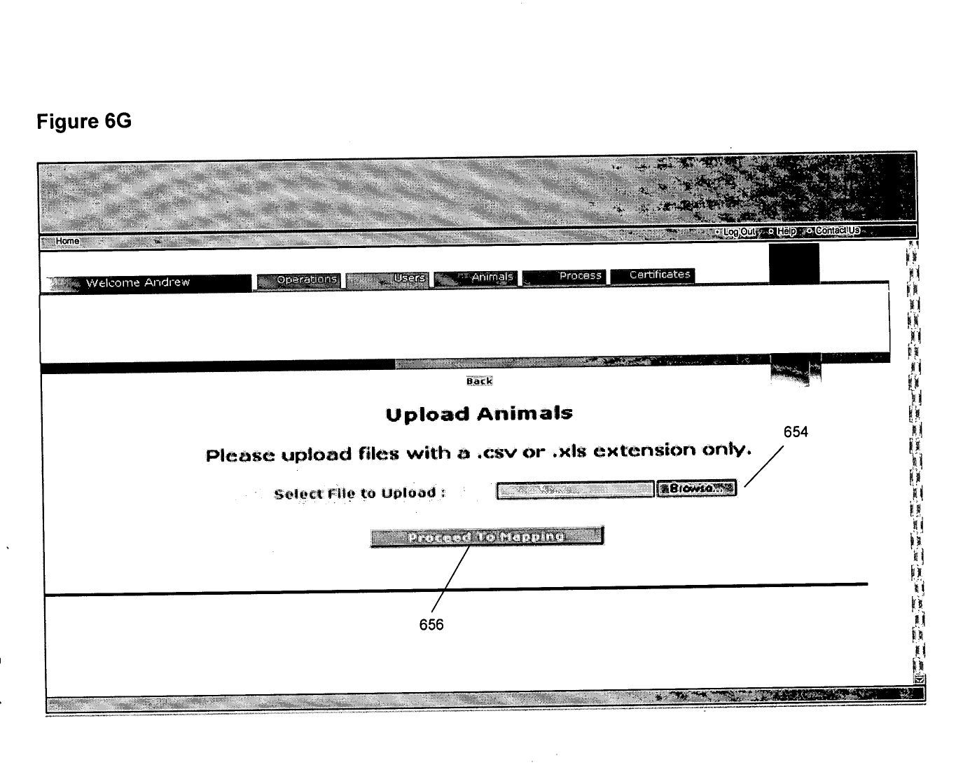

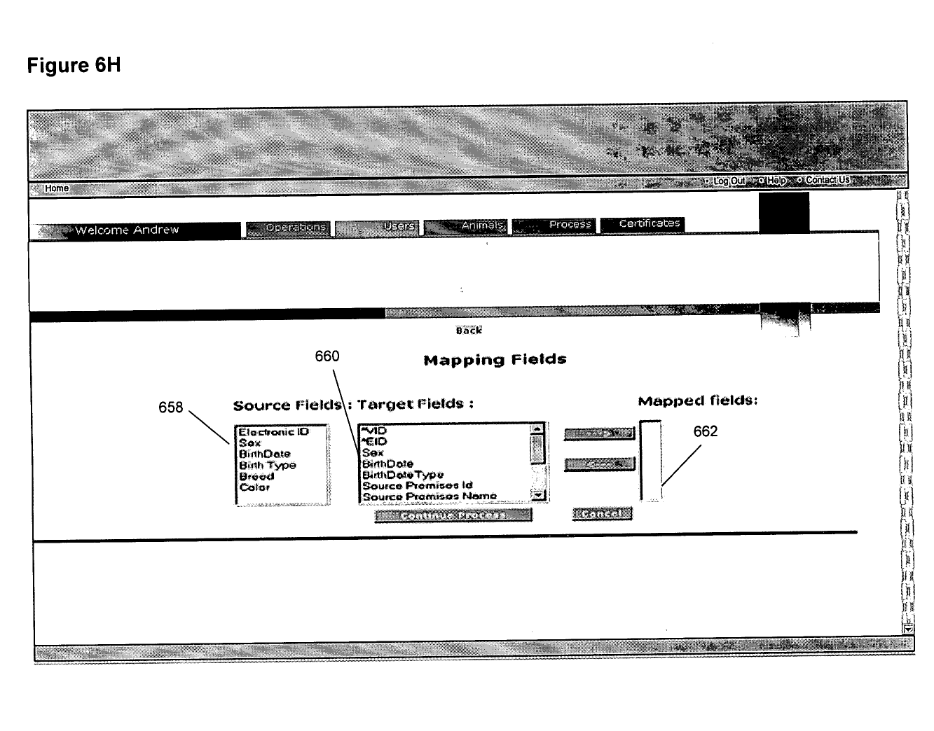

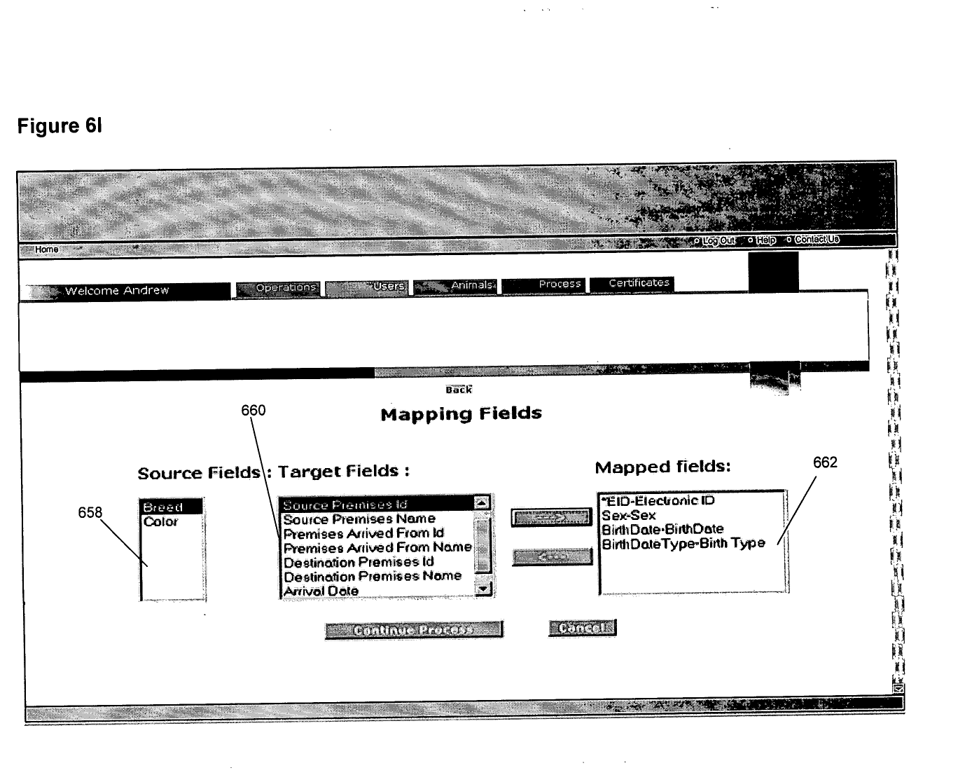

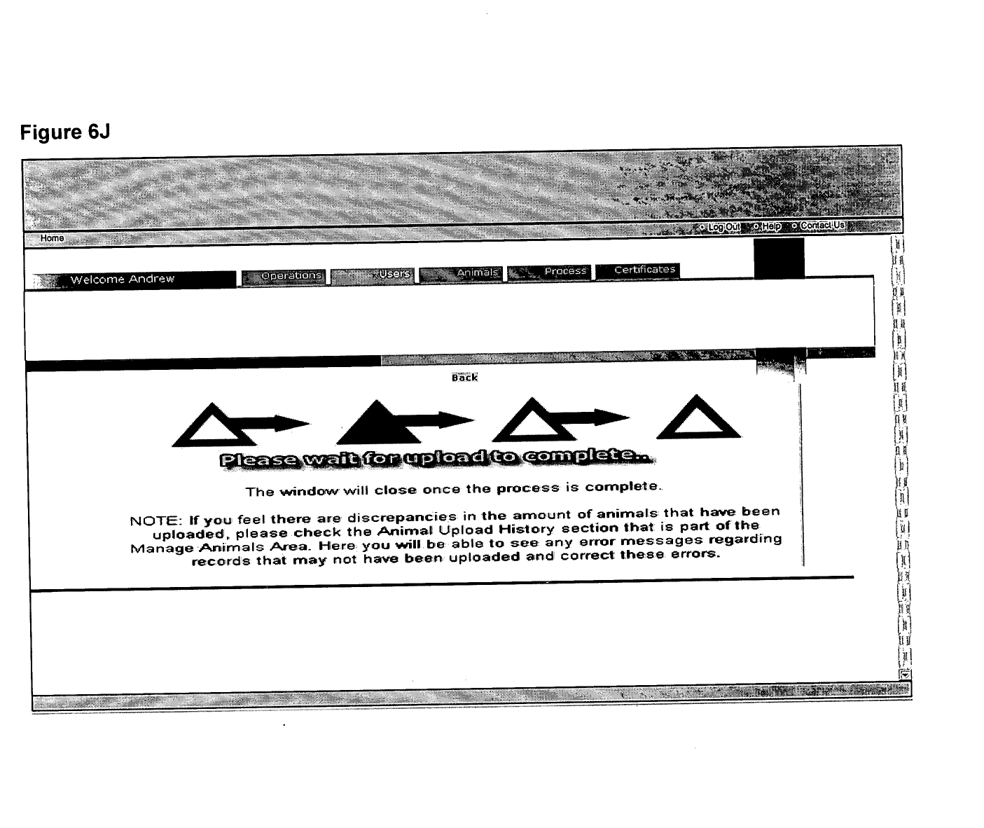

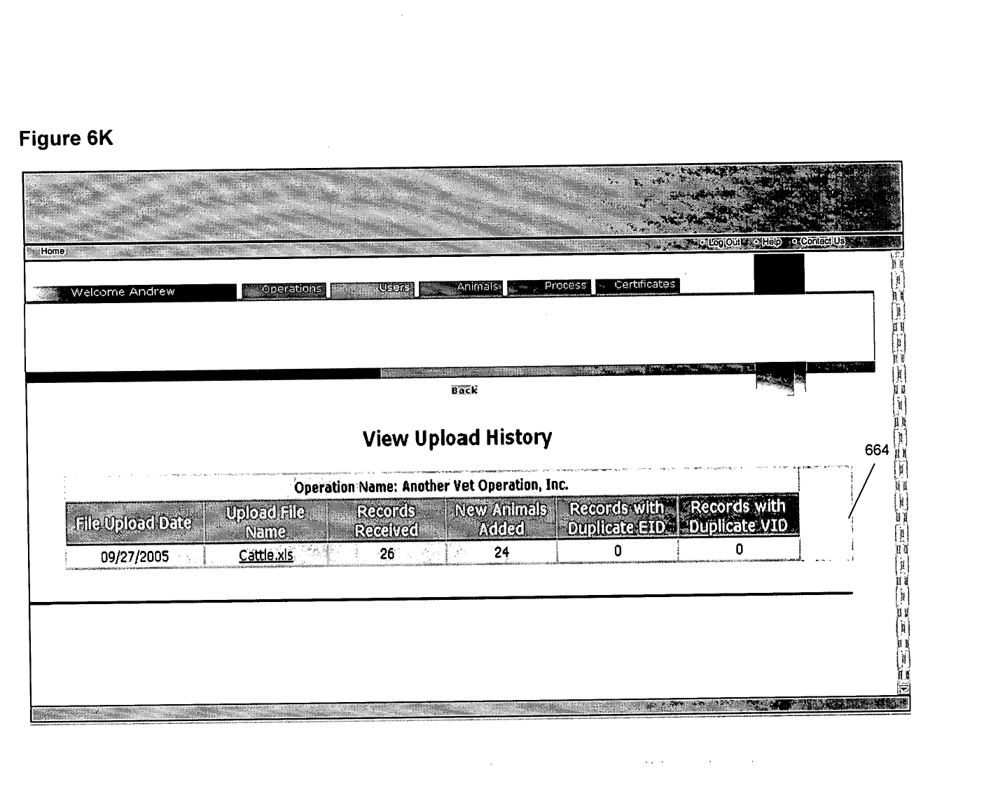

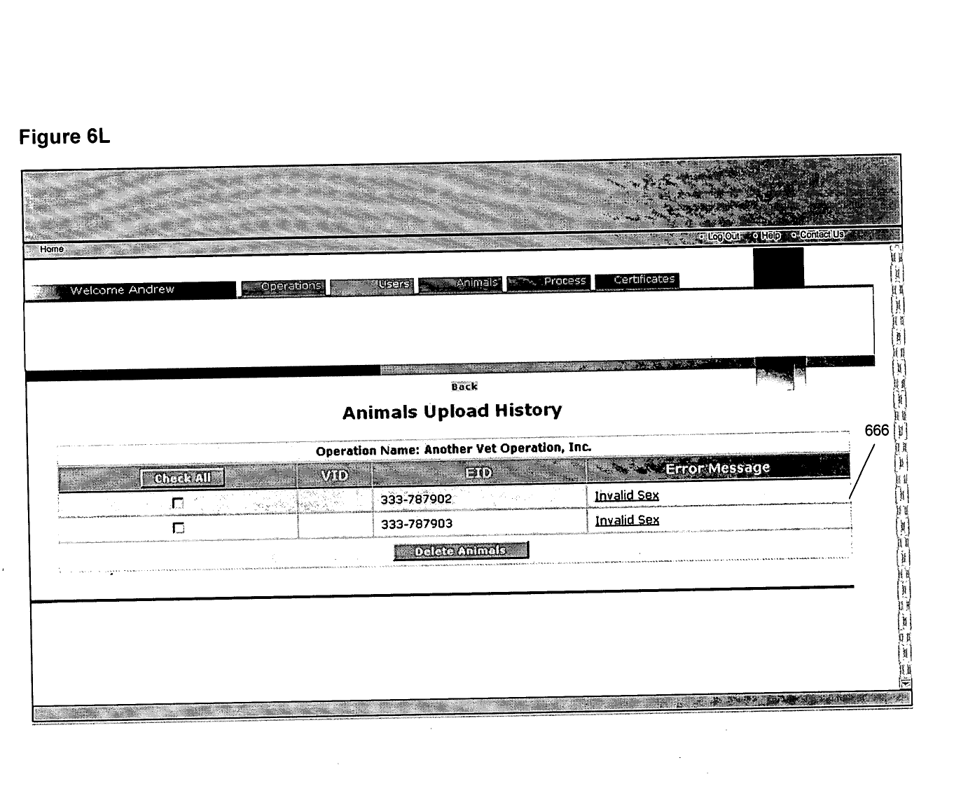

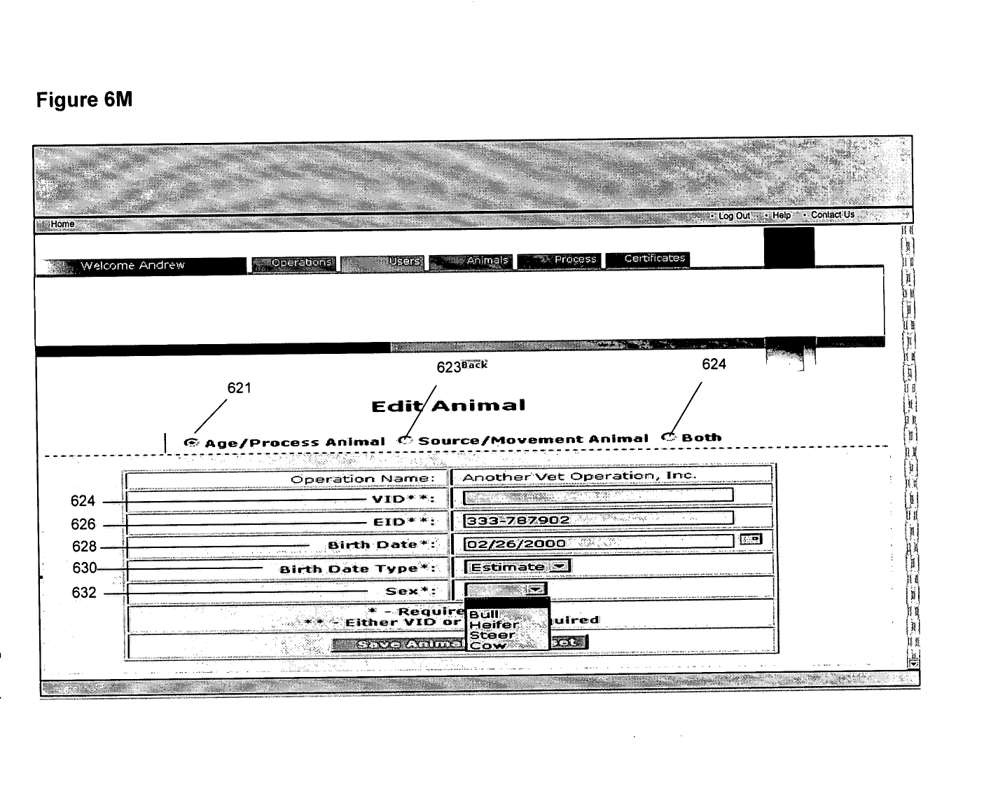

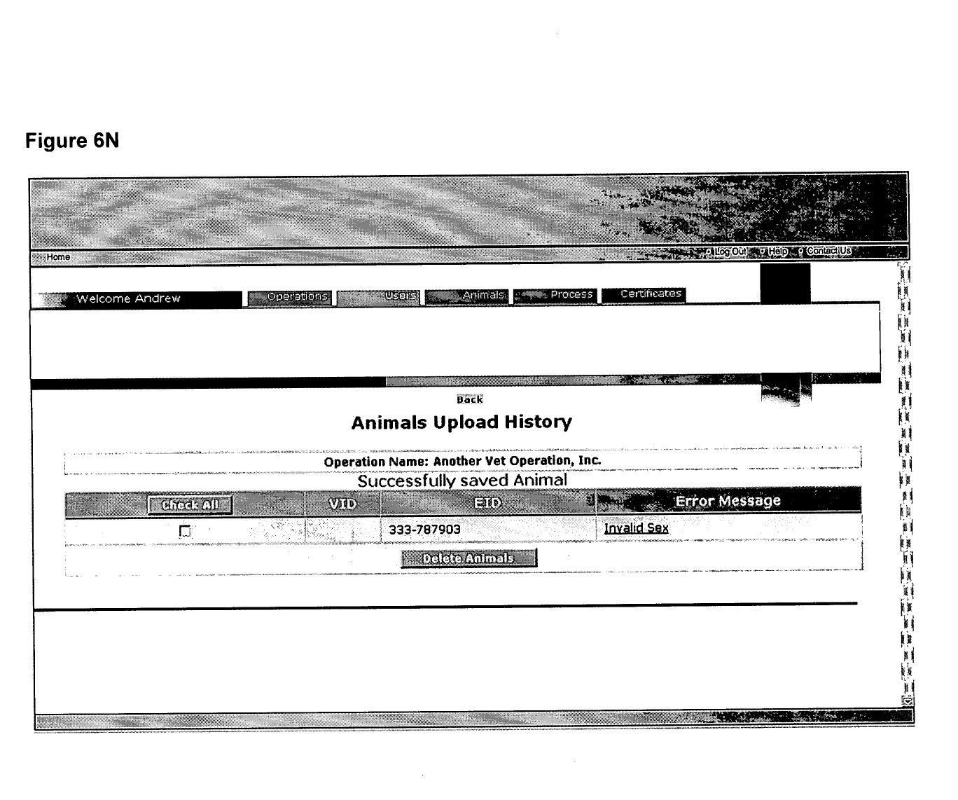

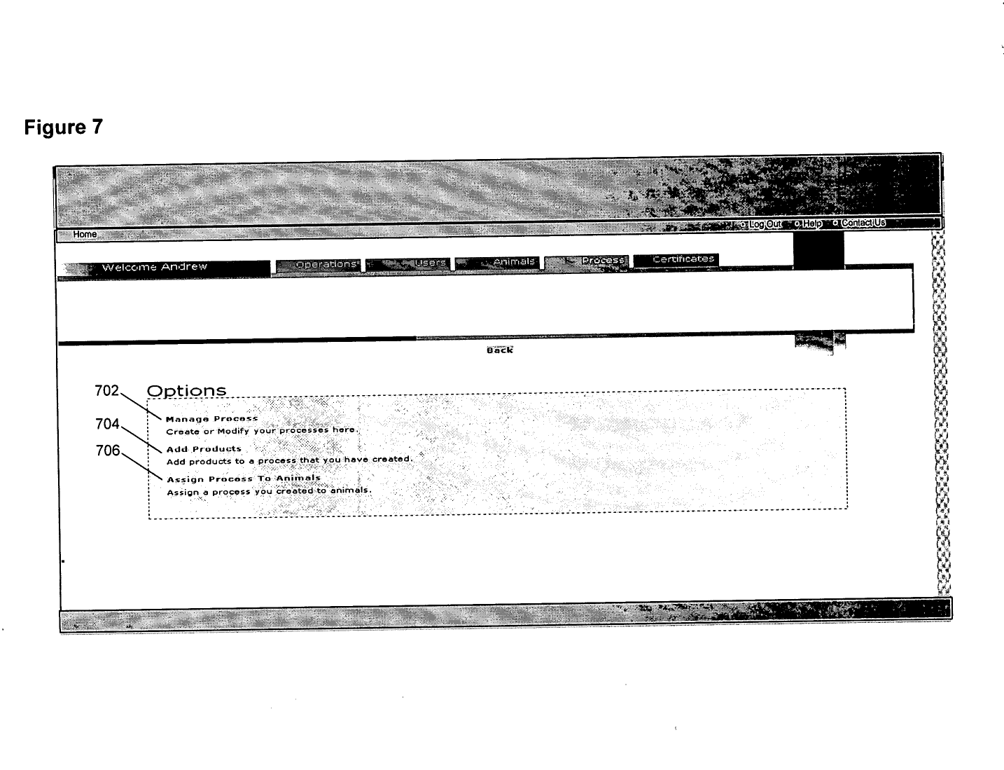

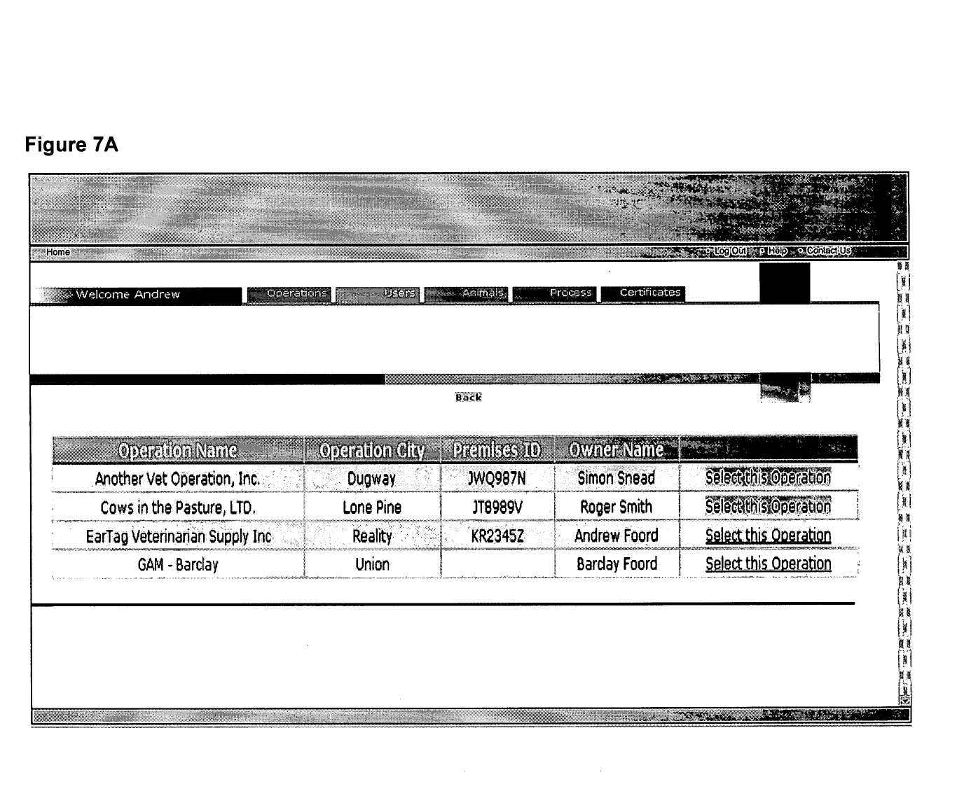

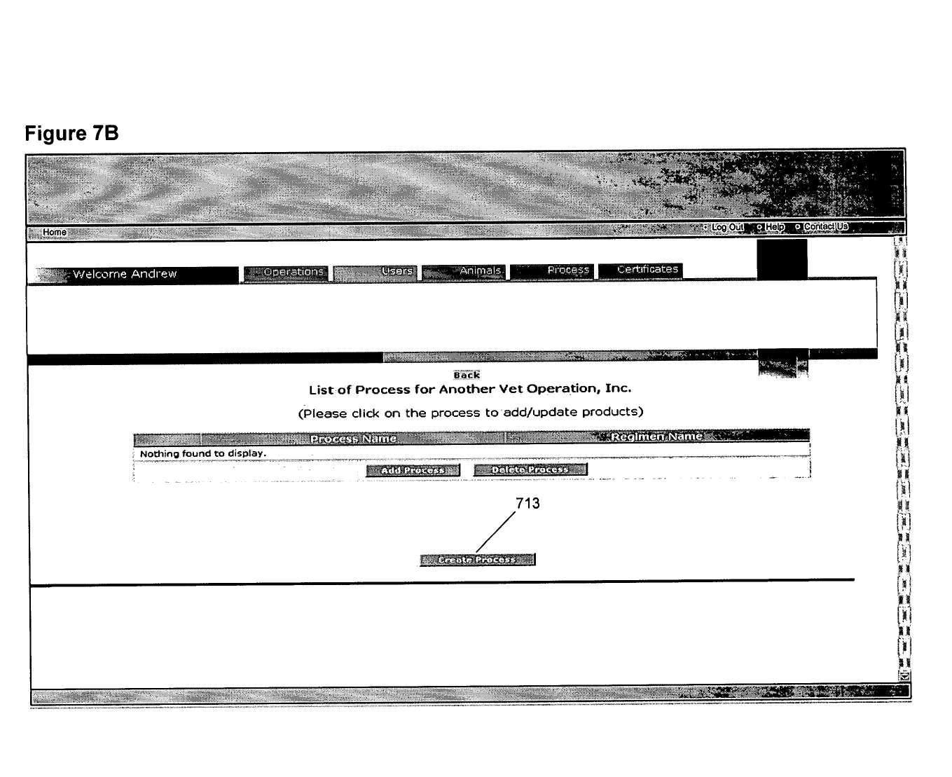

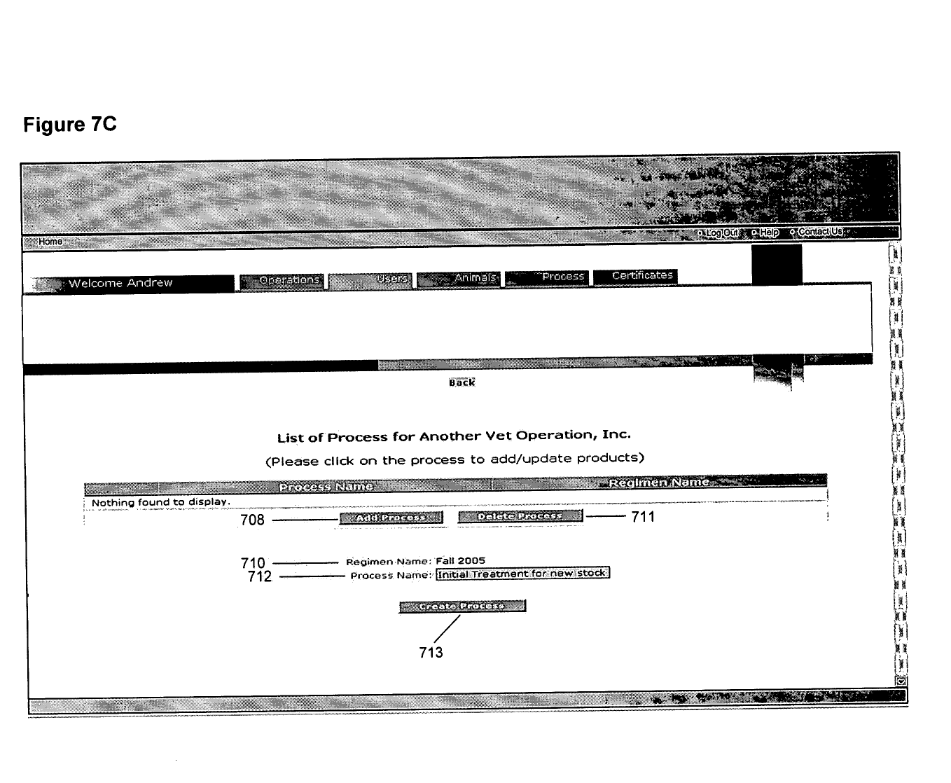

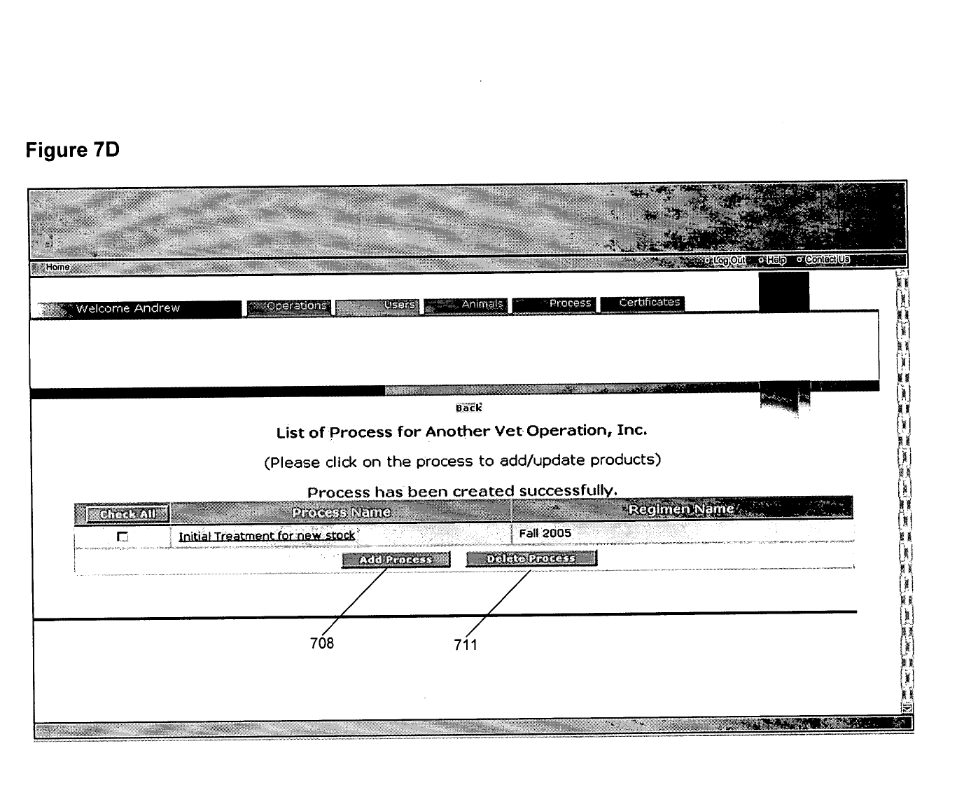

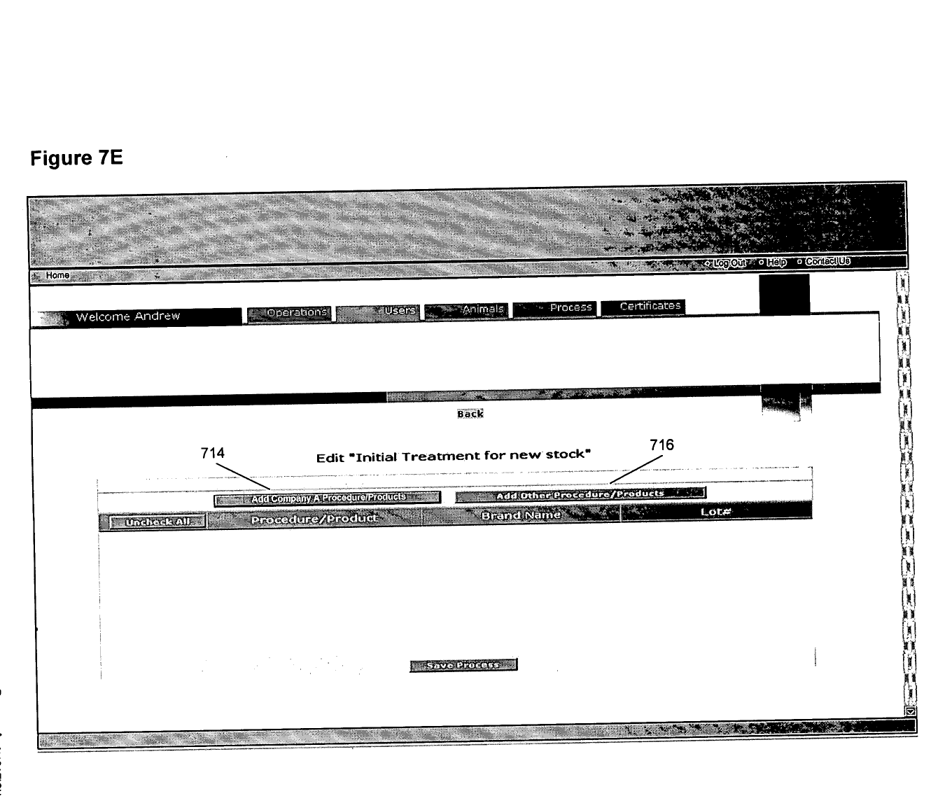

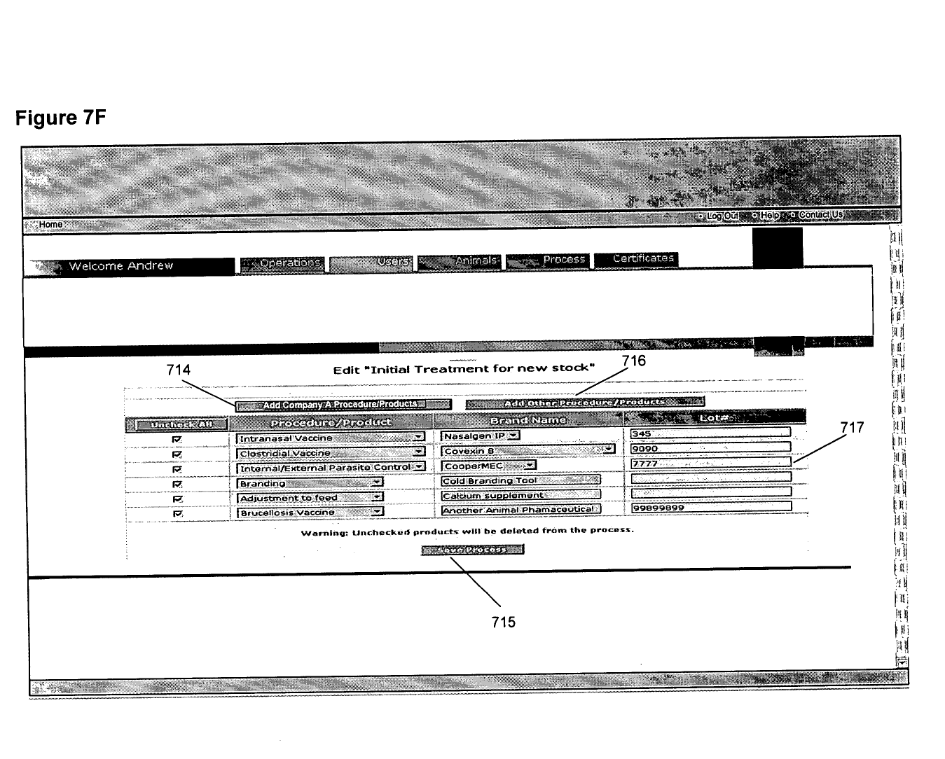

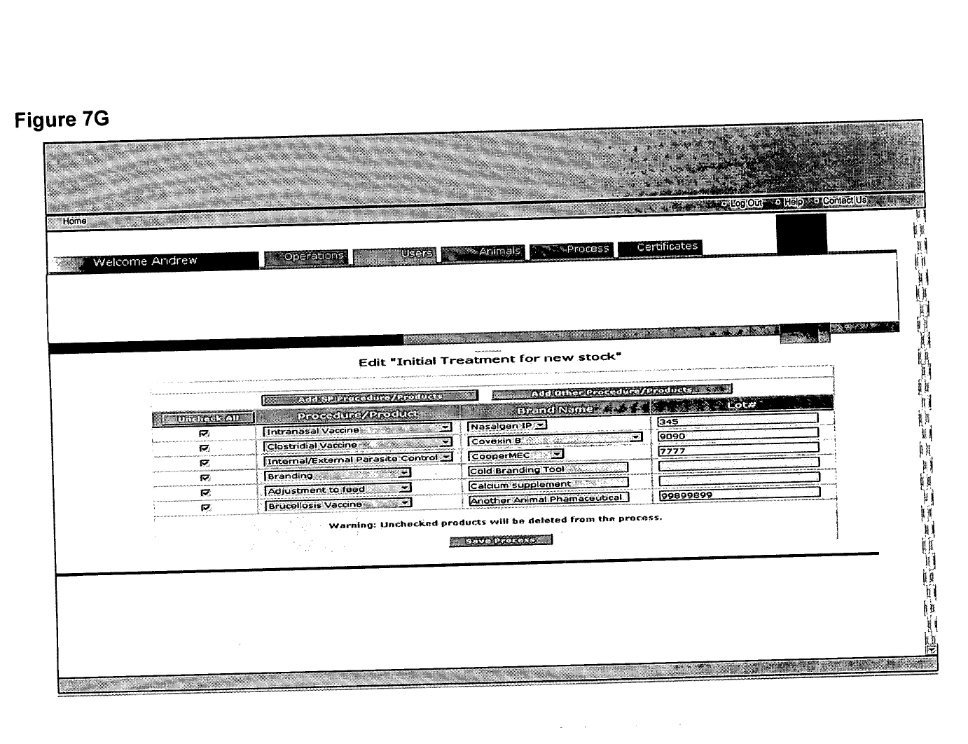

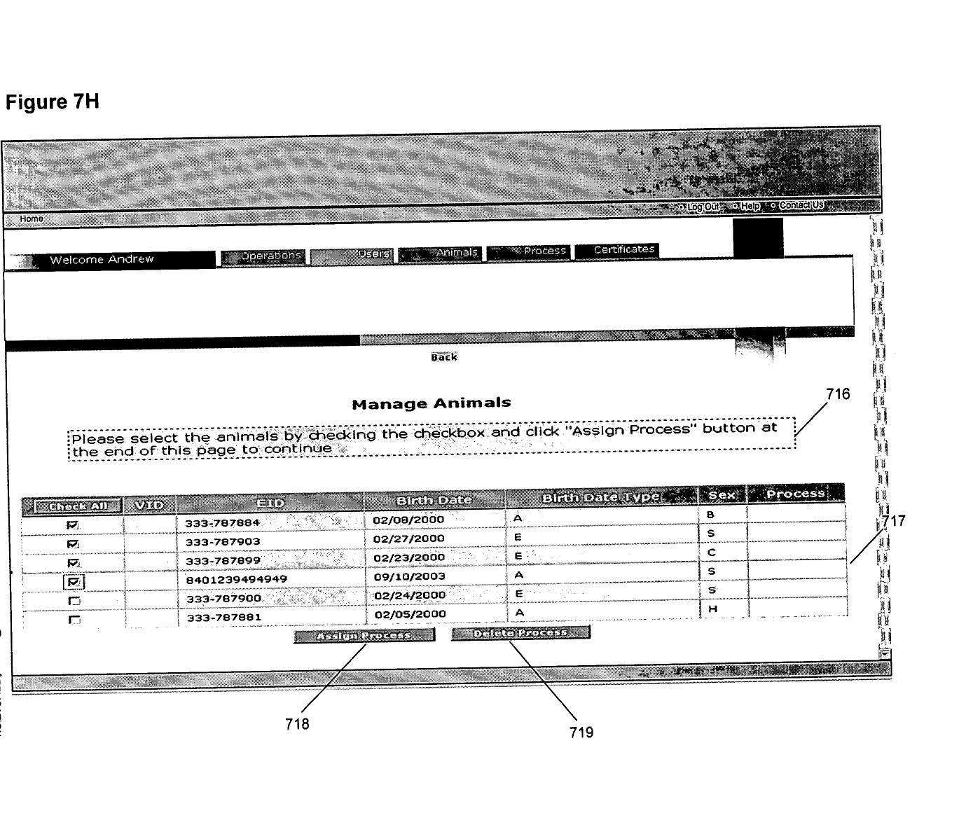

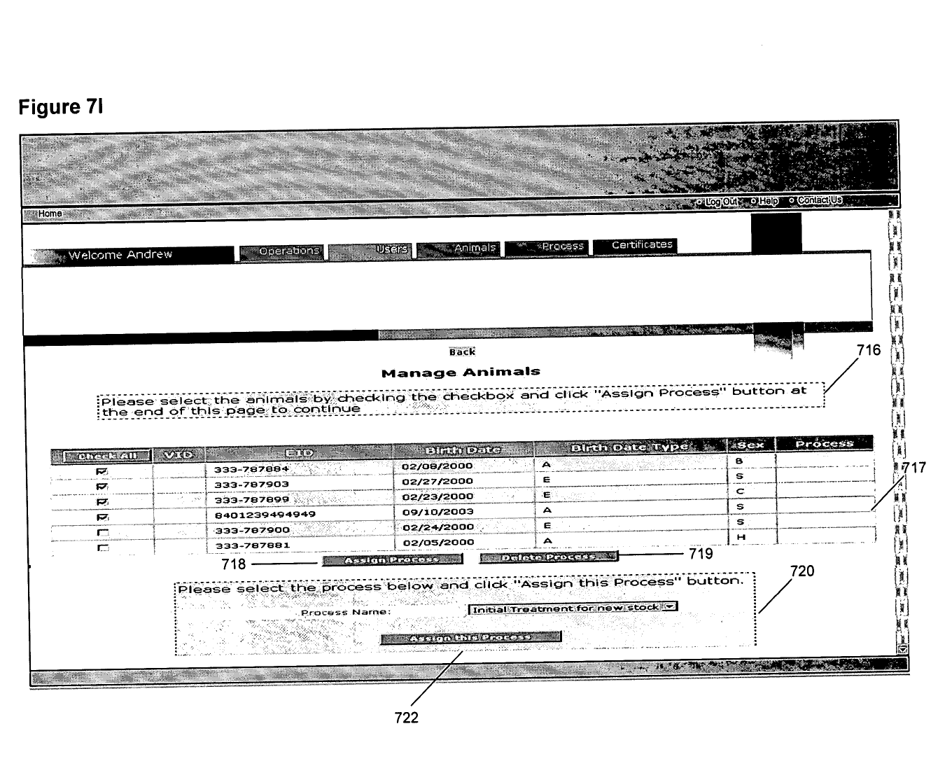

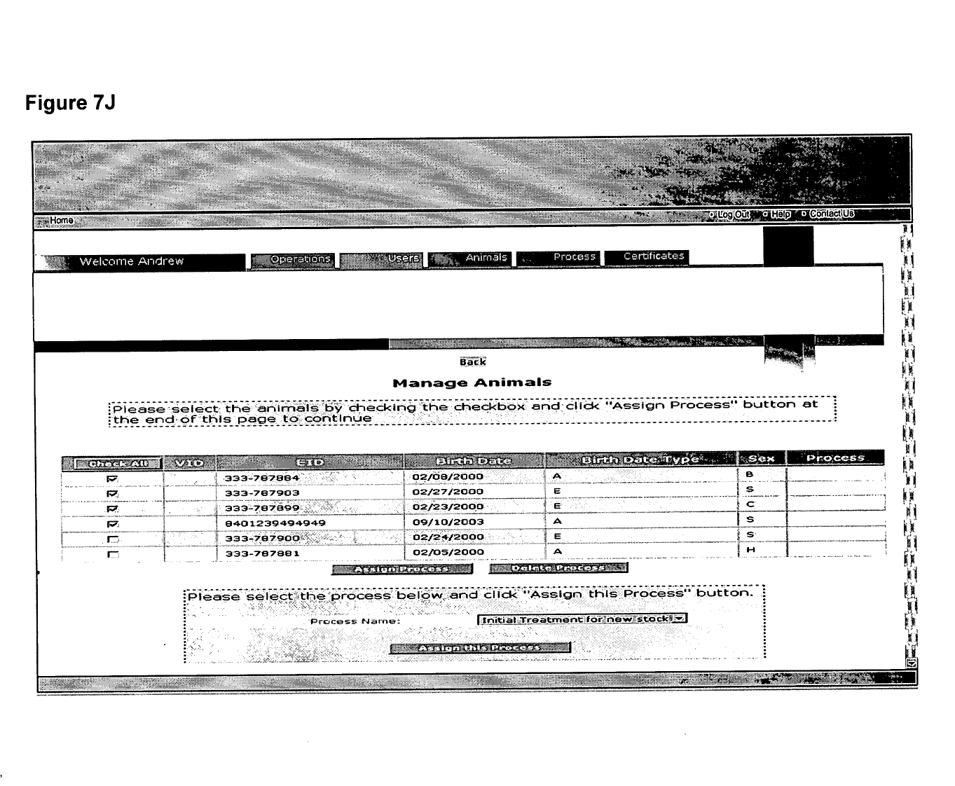

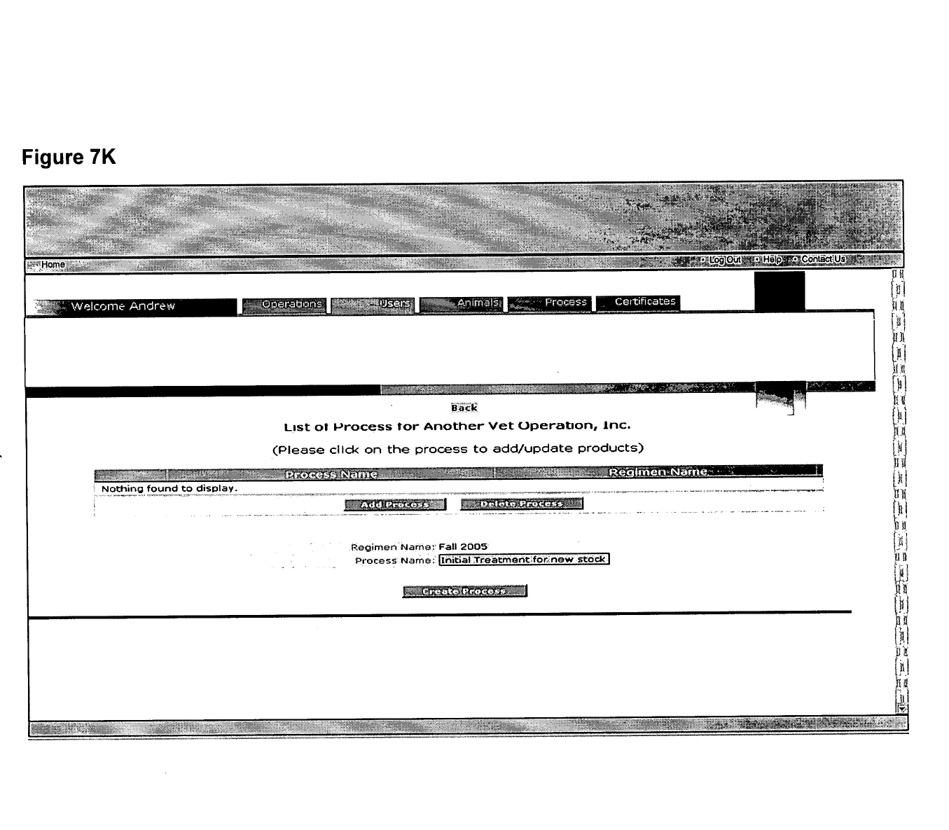

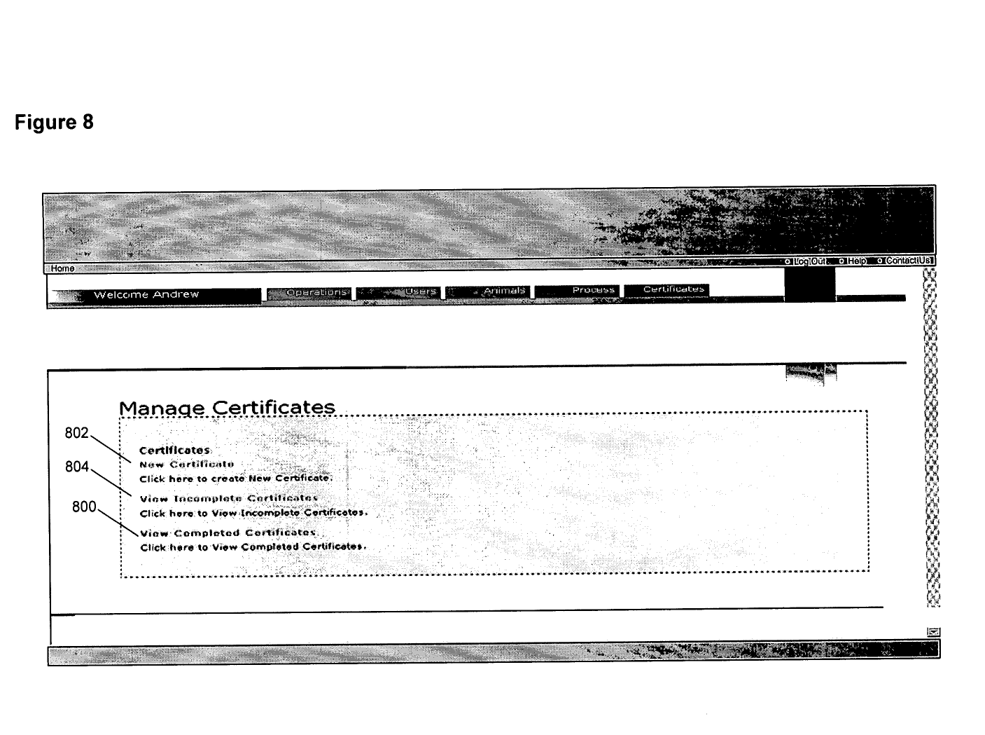

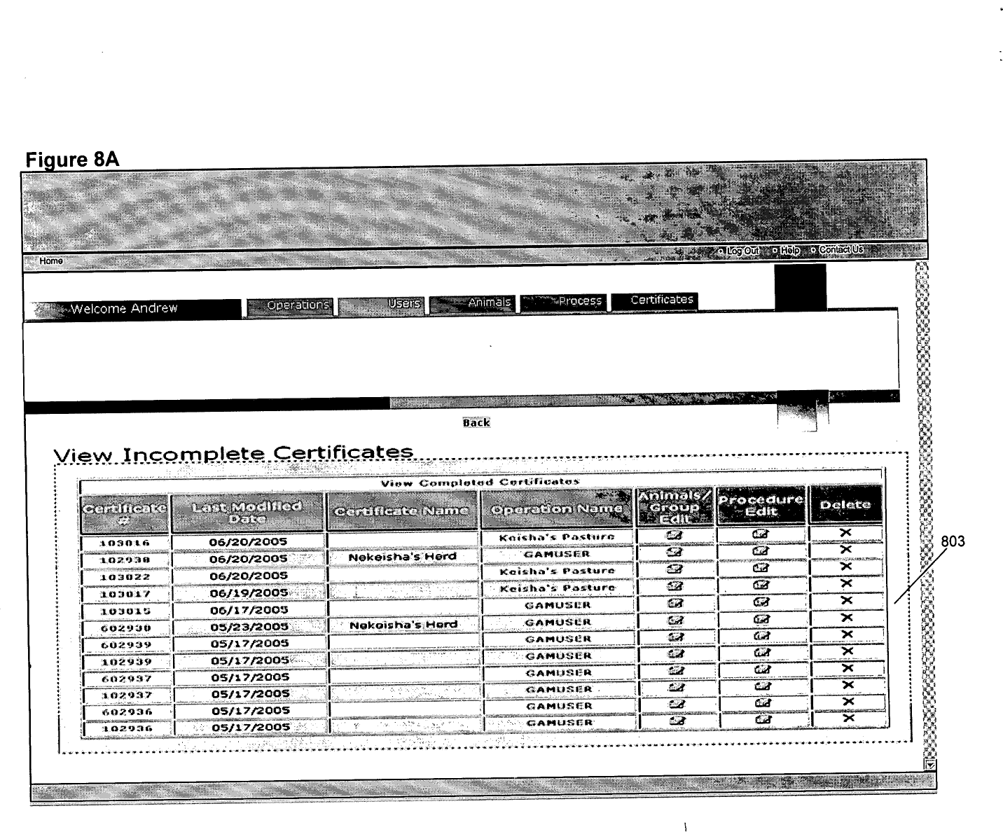

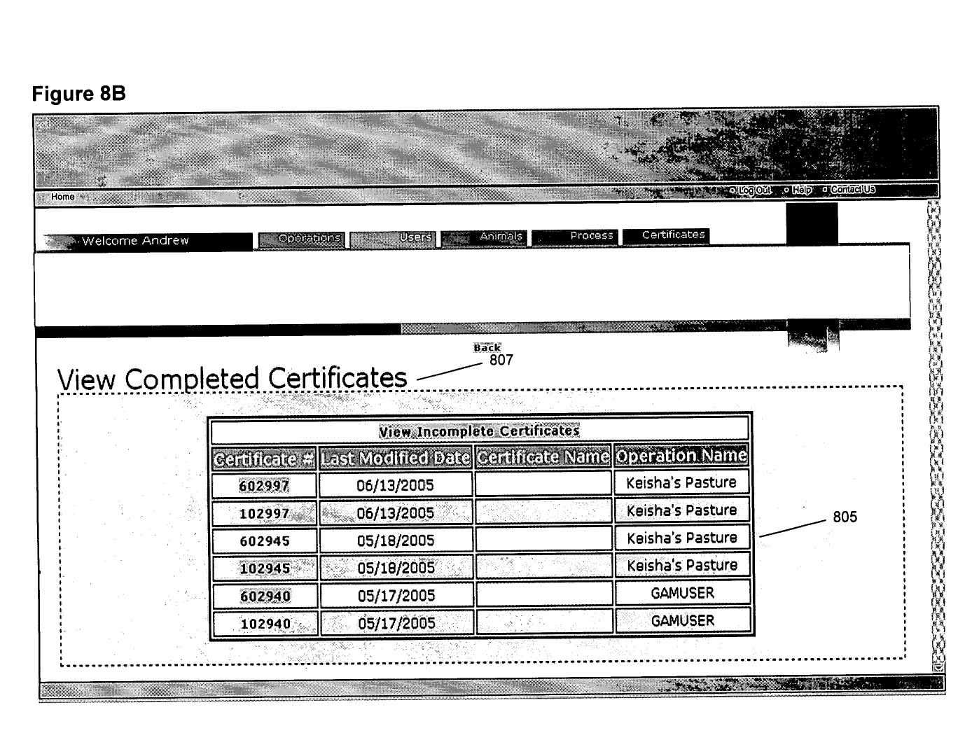

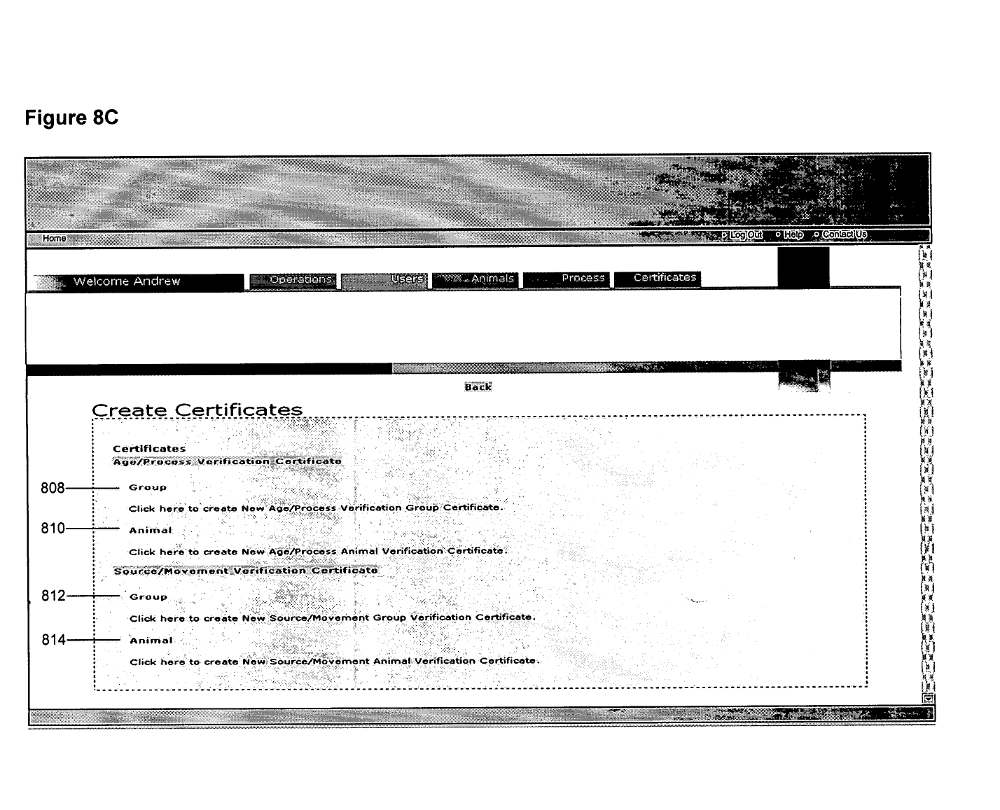

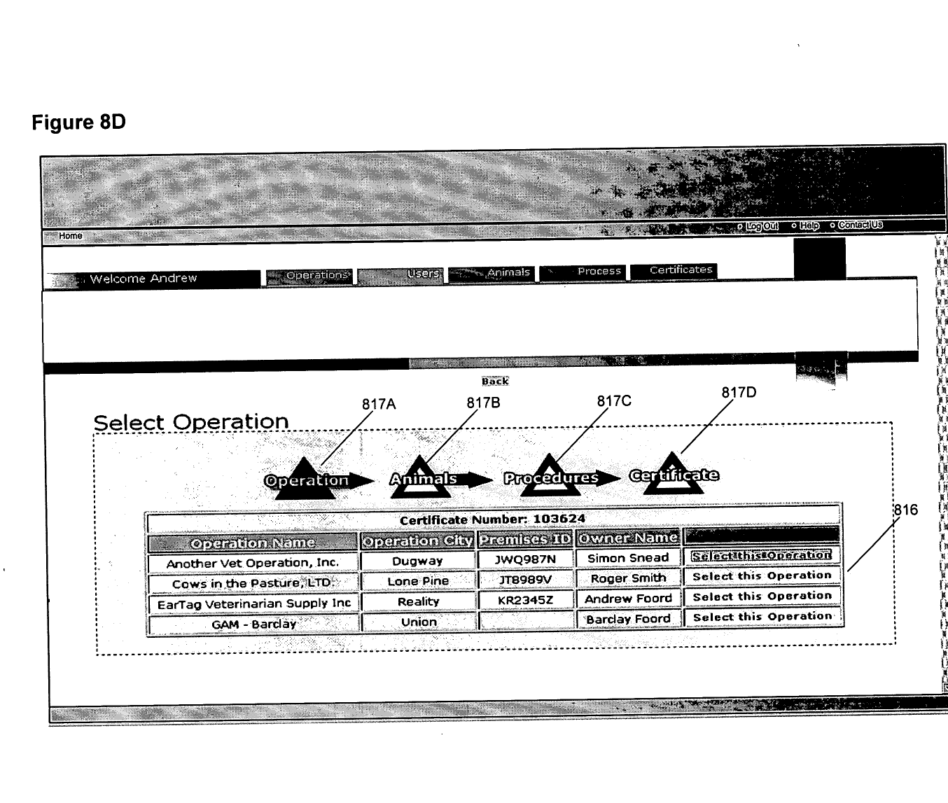

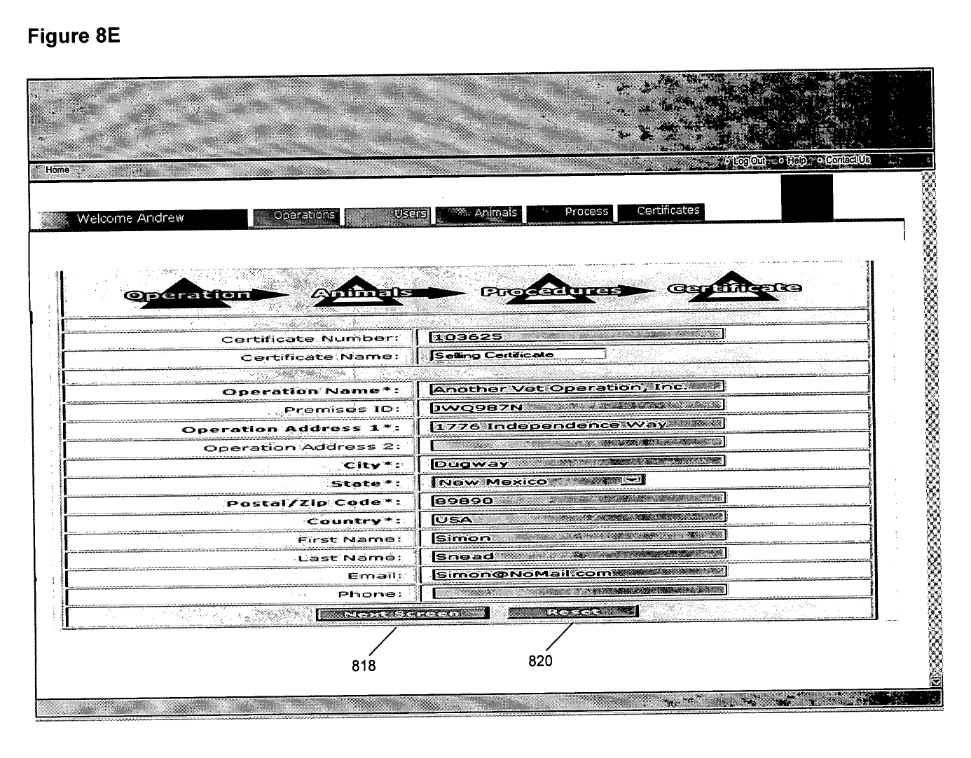

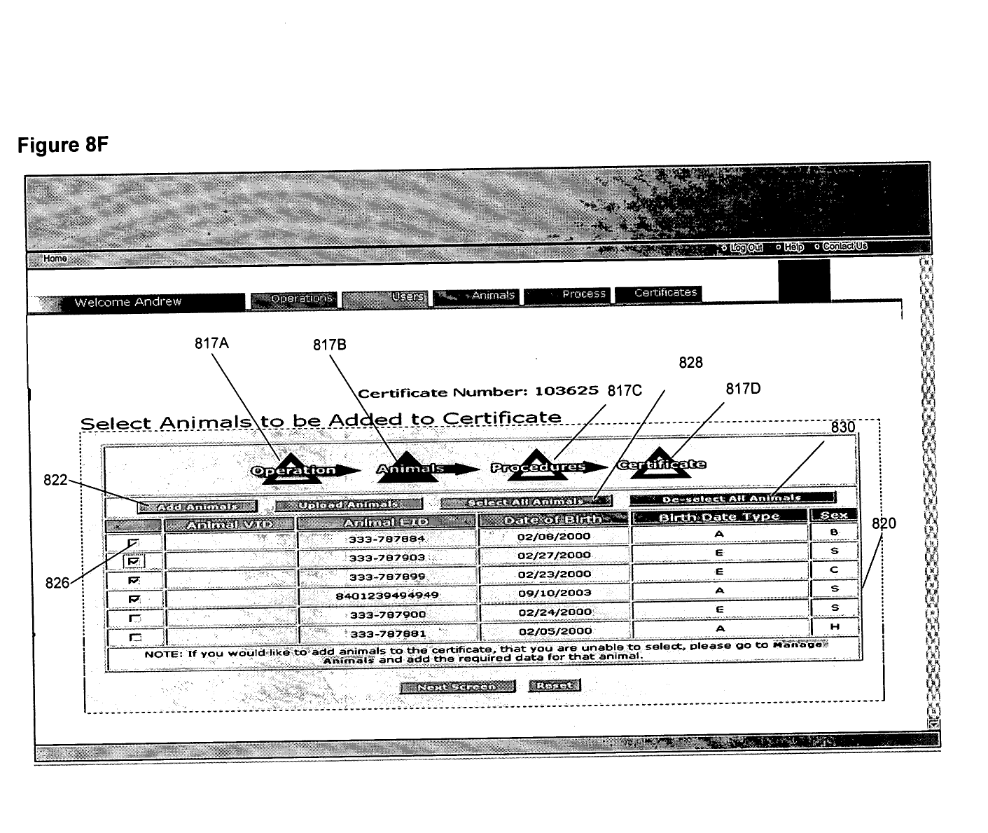

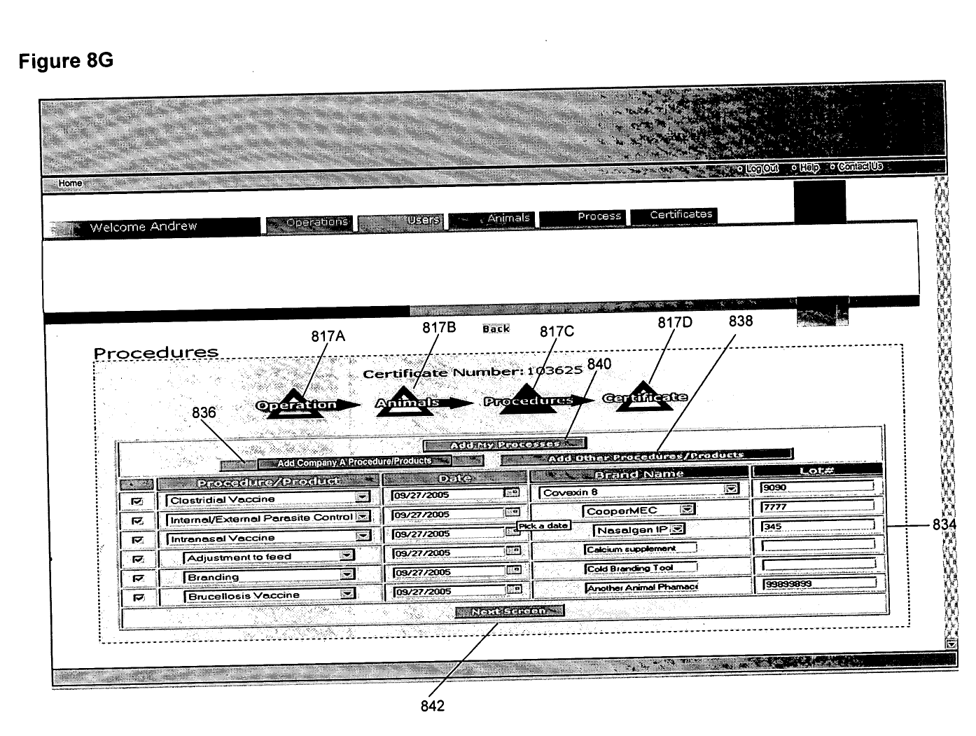

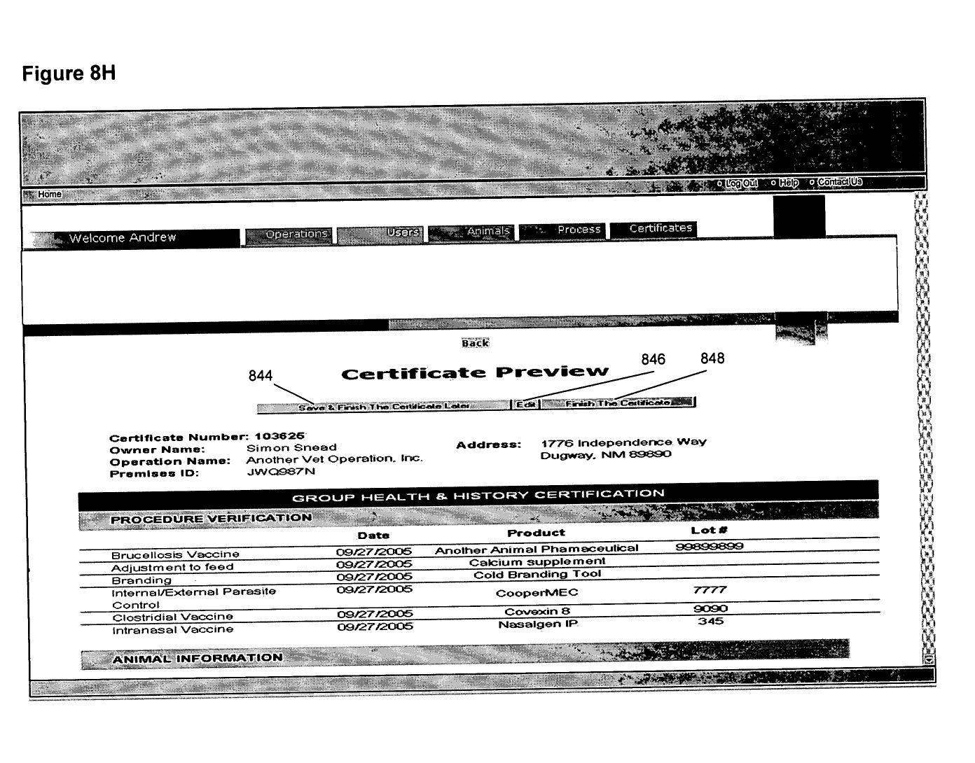

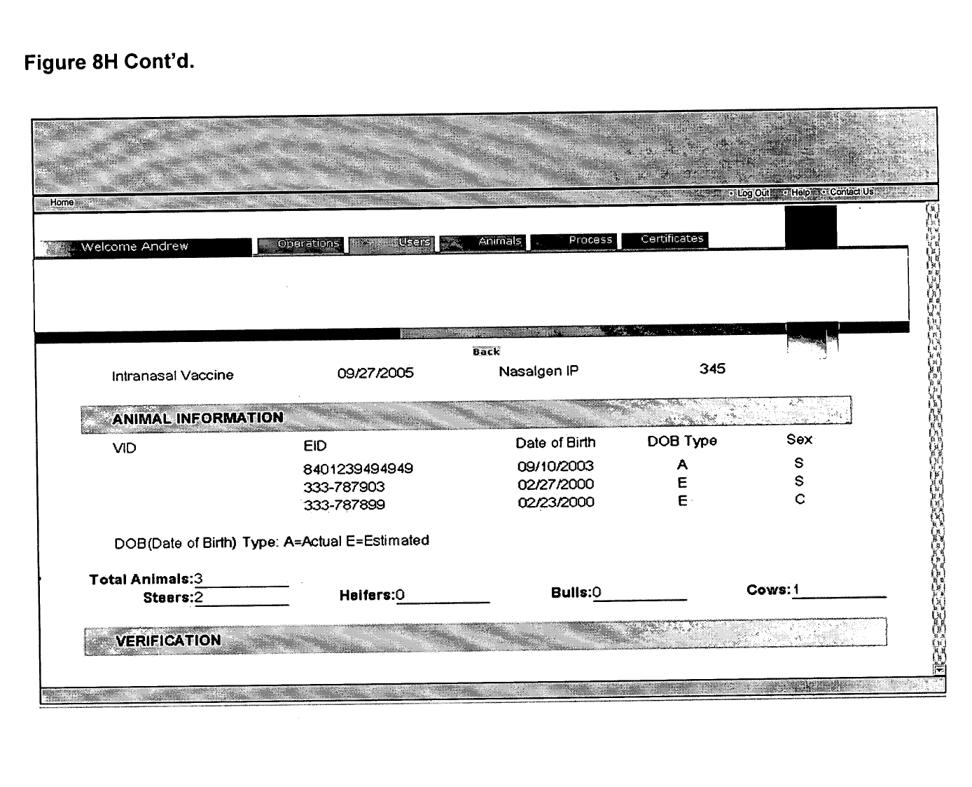

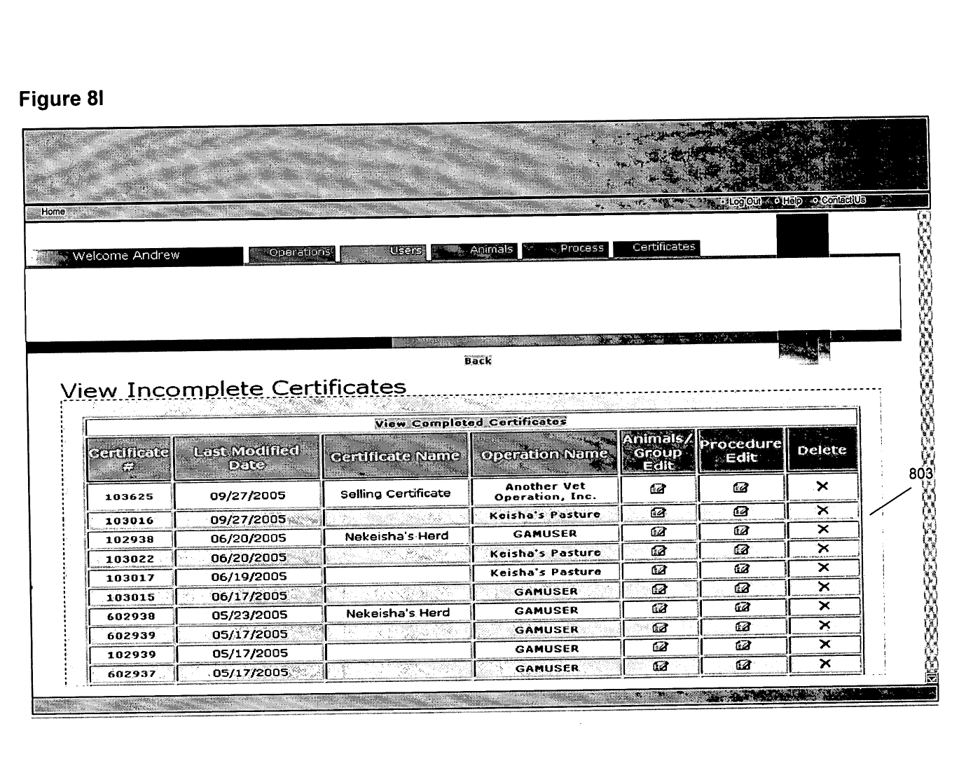

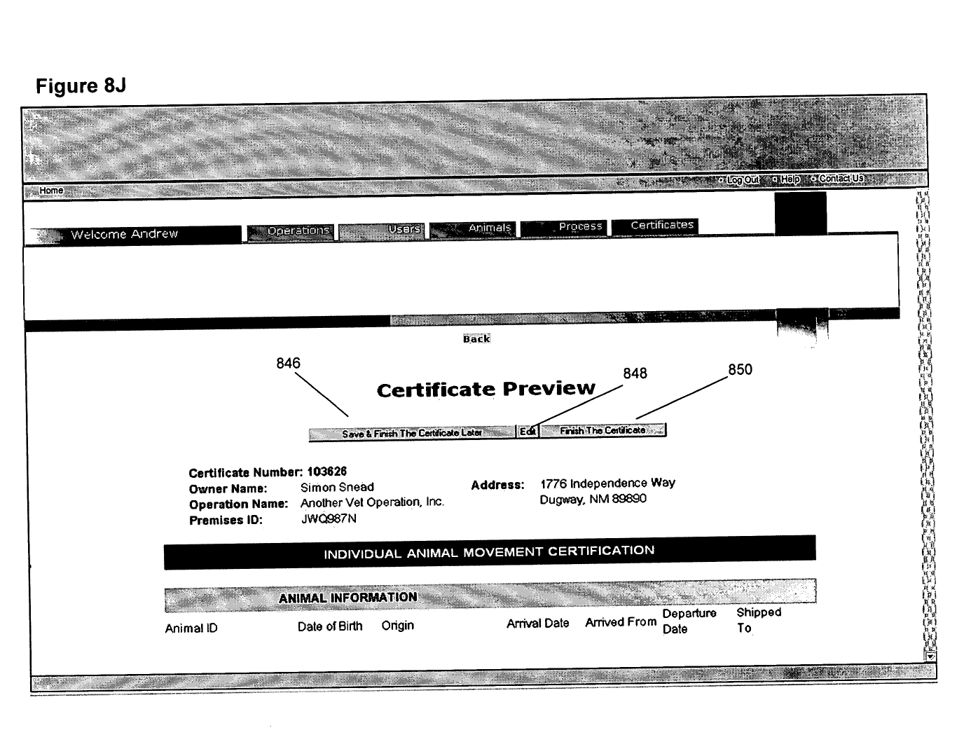

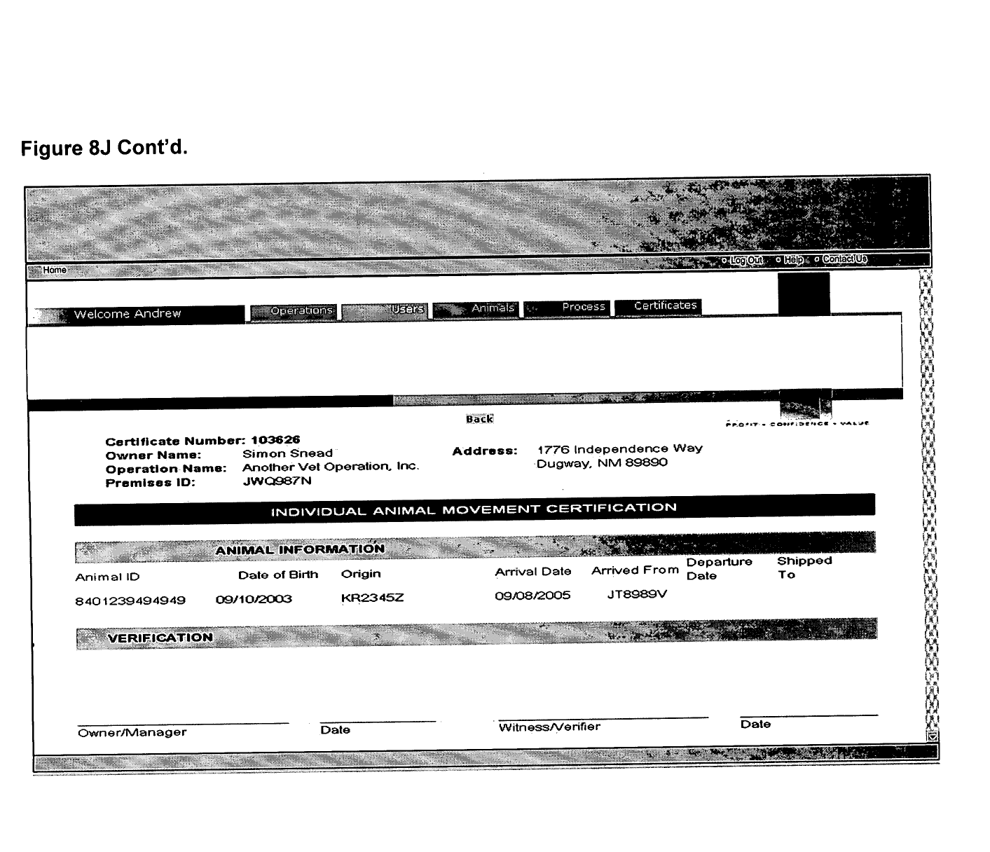

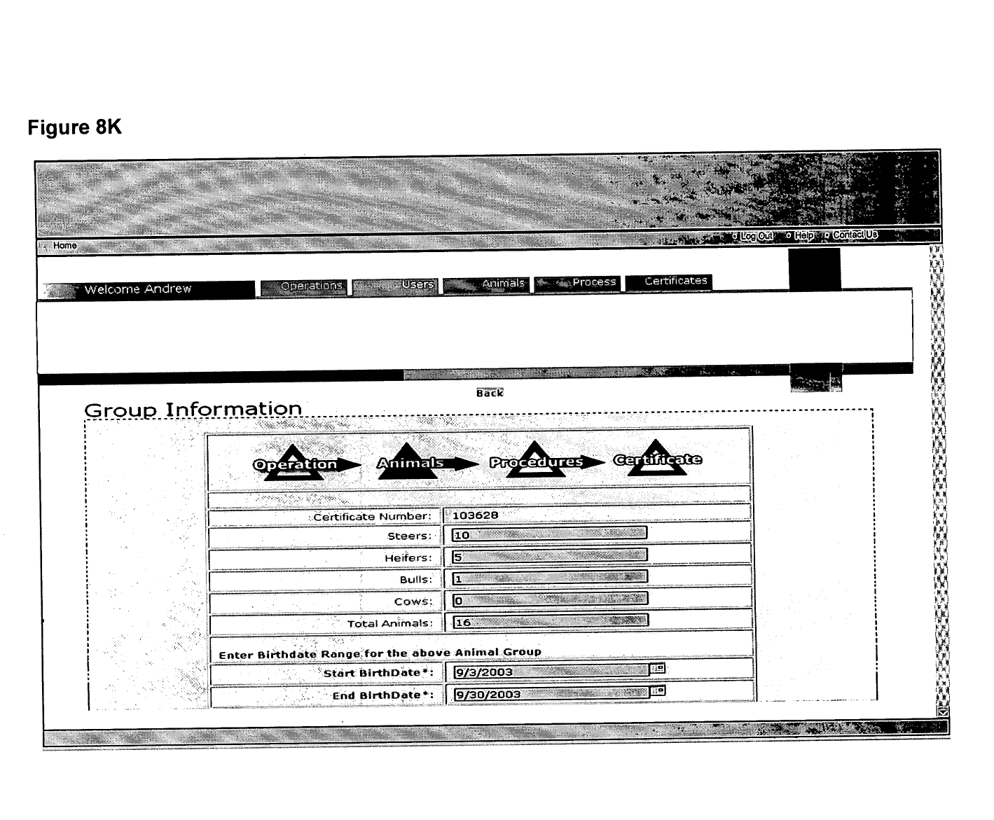

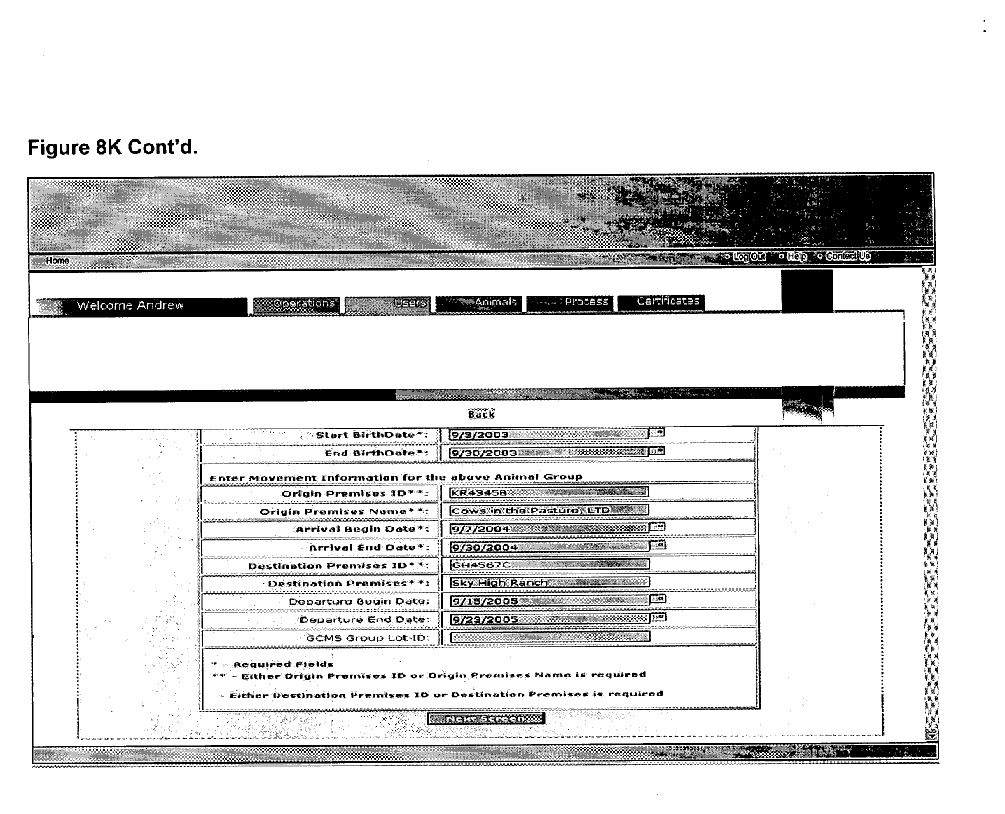

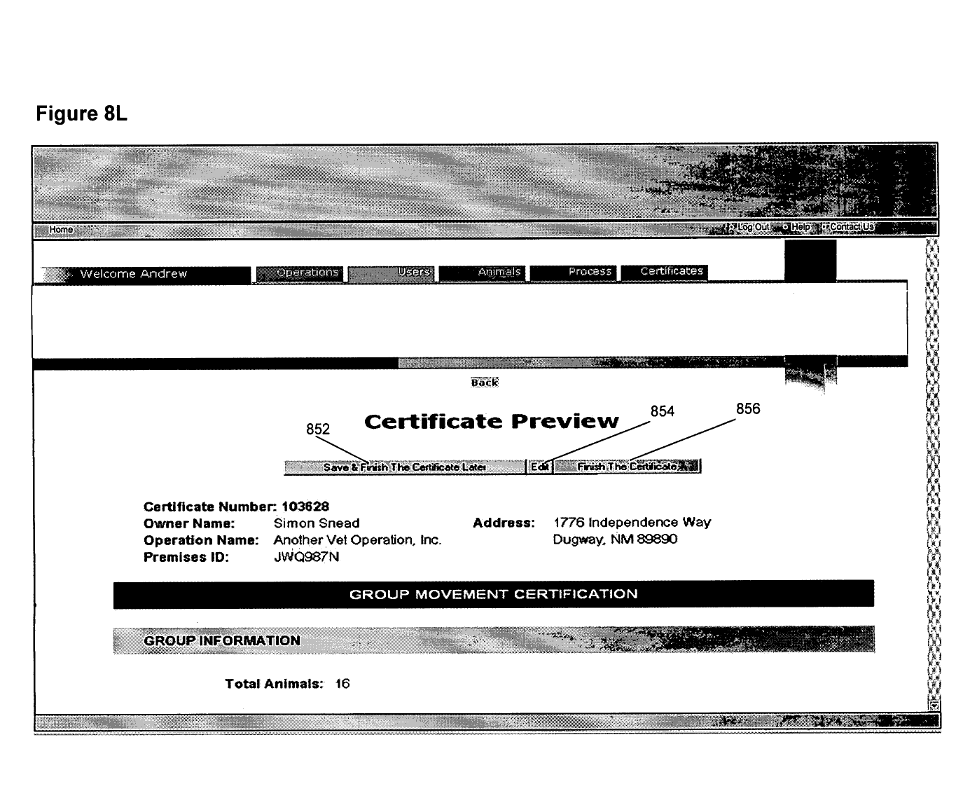

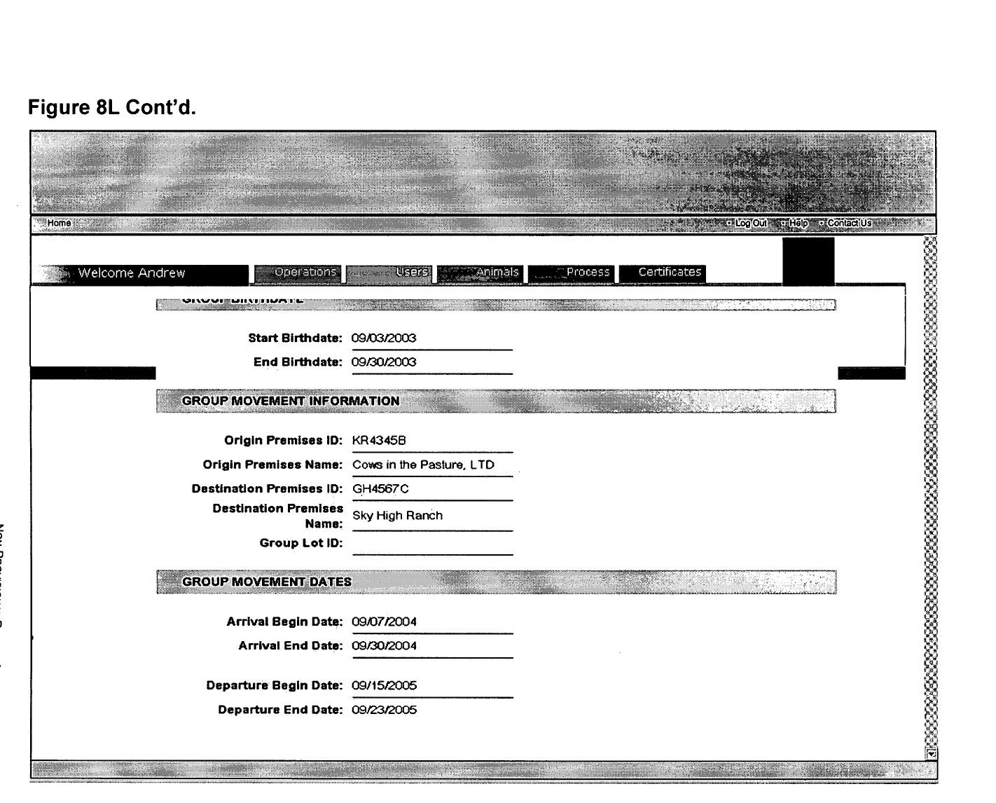

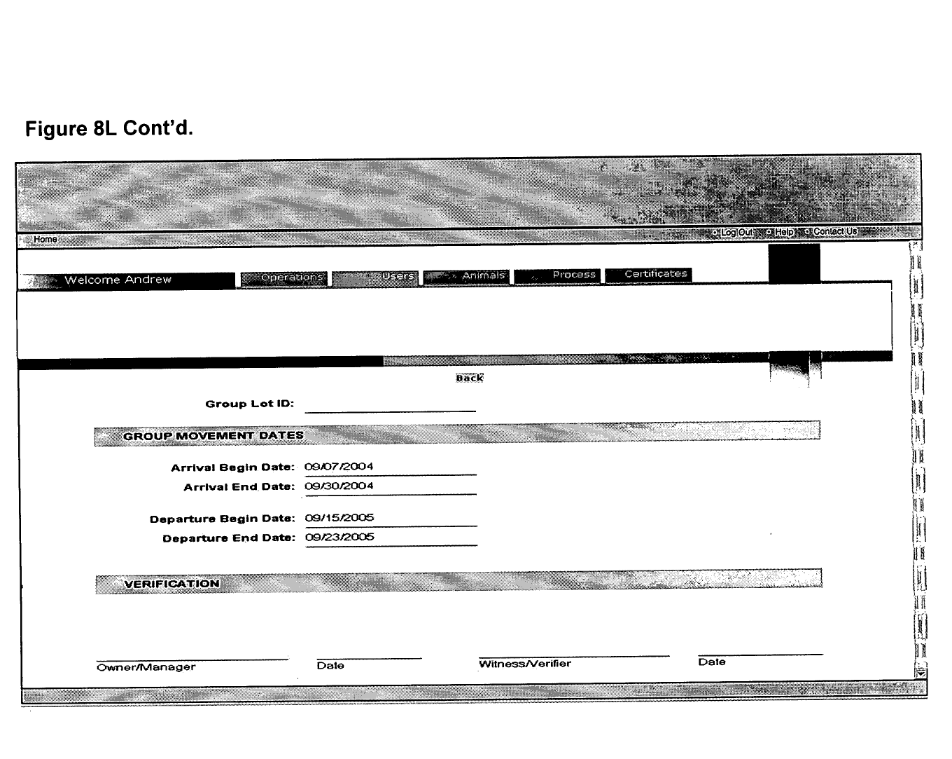

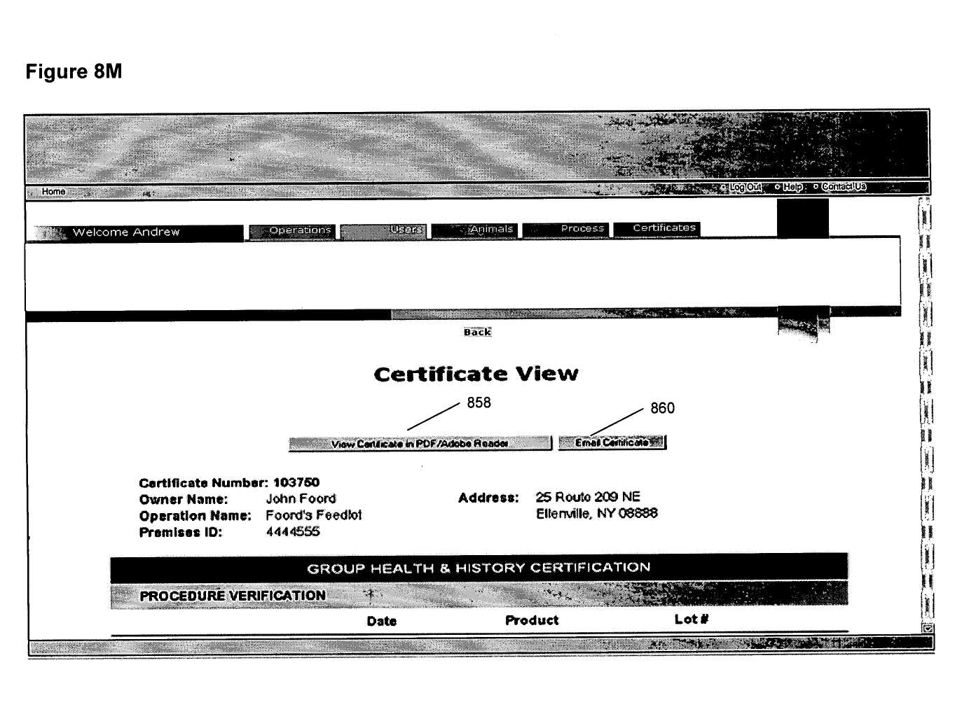

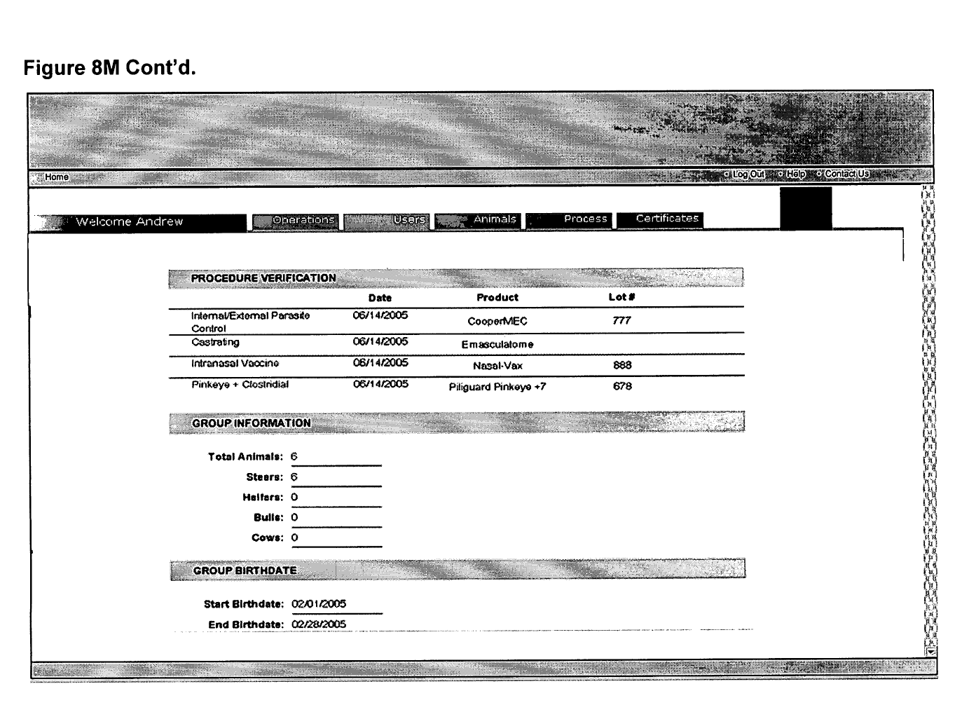

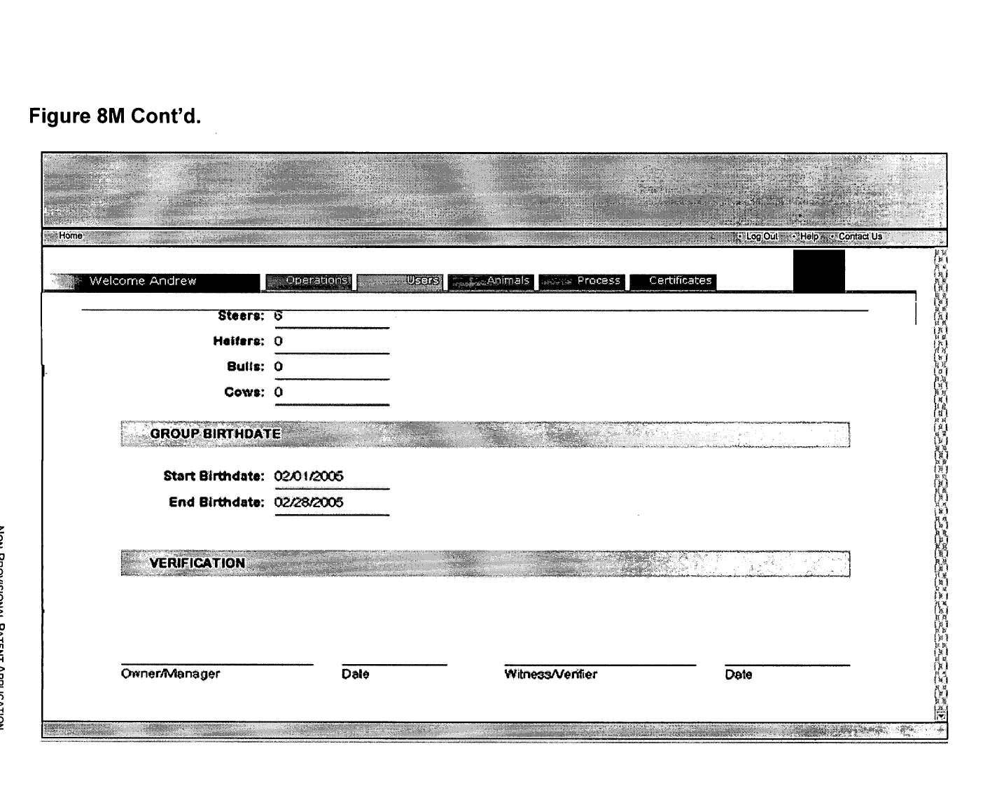

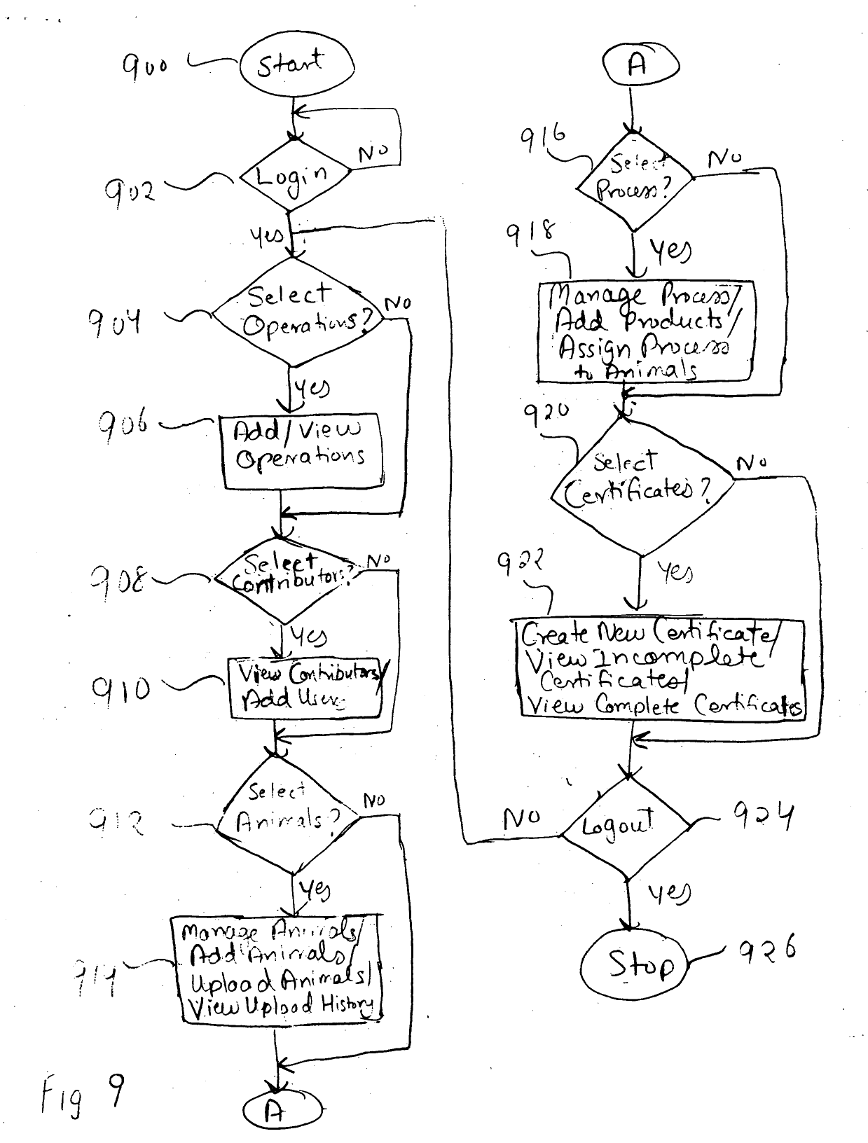

It is important to note that a facilitator has unlimited use to all the functions or action items, whereas a user has limited use to these action items. For instance, a facilitator can de-activate or activate a user, but a user cannot add new users, create/add new operations, or create/issue a certificate. Only a facilitator has the authority to perform these actions as will be described in greater detail below with reference to FIGS. 4, 5, and 8-. A user can perform other actions such as add, and manage animals, apply process to animals and create new process as will be described in greater detail below with reference to FIGS. 6 and 7 below. A system administrator (not shown) sets up a role for a facilitator and a user to be recognized by the system. The contributors 104 may employ a variety of wireless/wired devices to connect to the network, such as desktop computers, portable/laptop computers, wireless/wired personal digital assistants, cellular telephones, specific Web access devices (WebTV), etc. Also connected to network 102 is server 106 for storing data upload tool 107 to place animal seed data into a database 108. “Animal seed data” as used herein preferably comprises attributes associated with the animal. Some examples for the animal seed data are an animal identifier (visual identification or electronic identification), sex, birth date, estimated or known birthday, birth type, location or combinations thereof. A data upload tool is preferably independently crafted software designed to automate loading of animal seed data from a file into a database. A processor 110 is programmed to execute a program code, to upload seed data for the animal employing the upload tool 107 to place the seed data into a specific target fields of the database and initiate the individualized data set, as will be described in greater detail below with respect to FIGS. 6, 6A-6N. The processor 110 executes a program code to also allow input of husbandry process for that animal in the database 108. An “animal husbandry process” as used herein is a property of an animal added to the database that can be linked to the corresponding seed data of that animal. An animal husbandry process can comprise any process performed on the animal, which preferably includes medical treatment, pharmaceutical operations or combinations thereof. Such processes include dehorning, castration or any other treatment or operation known to perform on an animal. An husbandry process is added to the individualized data set initiated for the animal as will be described in greater detail below with respect to FIGS. 7, 7A-7K. The processor 110 further executes a code to provide and issue certificates, as will be described in greater detail below with respect to FIGS. 8, 8A-8M. The processor 110 also performs other functions such as process data, access a database and/or perform all other operations as described herein. Database 108, connected to server 106, stores the seed data and the husbandry process representing livestock health and history data, as well other data representing information in connection with the embodiments of the present invention, as explained in detail below. Also stored in database 108 may be contributor's registration data to gain access to the system. It is understood that the database may be remotely located from the server or, alternatively, may be co-located with the server. Furthermore, the database may be a distributed database, comprised of a cluster of databases. Although, FIG. 1 illustrates that the database 108 and the processor 110 as components separated from the server 106, it is noted that the database 108 and the processor 110 can preferably be stored or be part of the server 106.

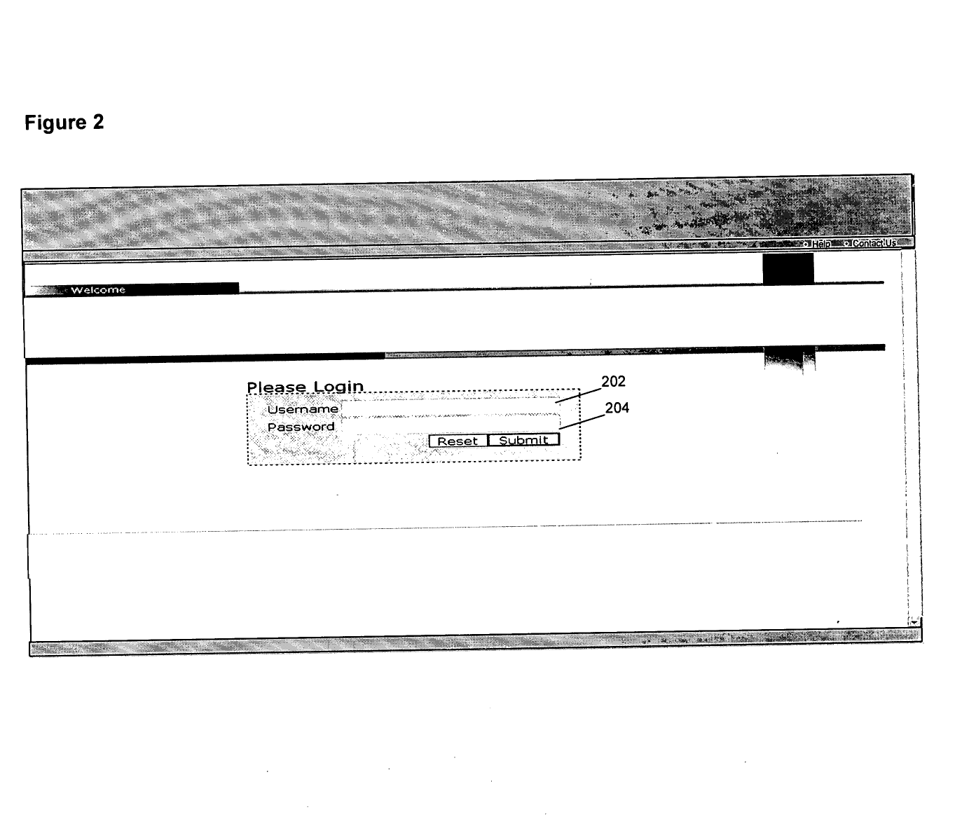

According to one embodiment of the present invention, the contributor 104 preferably wishes to access the system to generate an individualized data set for an animal and/or provide a certificate for the animal. Using any of the known devices as discussed above, the contributor 104 establishes communication-via network 102—with server 106 that hosts a web site in accordance with one embodiment of the present invention. The web site is typically accessed by entering its Universal Resource Locator (URL) address in a browser program. The server responds with HTML-based documents representing the web site. It will be appreciated that any protocol, markup language, etc., may be used between clients and a server to transfer files, web pages, etc., therebetween, as known to those skilled in the art. Typically, the web site home page 200 is displayed initially, with a login procedure implemented to allow only the registered contributors access to the web site contents as shown in FIG. 2. In this regard, the contributor 104 is requested to enter his/her username in field 202 and password in field 204 for authorization and confirmation. The entered information is transferred to the server 106 and checked against the pre-stored information in the database 108. The server 106 verifies the entered information by cross-referencing it against the registered contributor information stored in the database 108. If the entered information is valid, the access to the system is allowed. If, however, the entered information does not correspond to the database-stored information, an error message is displayed on the screen of the contributor's device, and the contributor 104 is invited to re-enter his/her access information. The login screen may not appear after a certain number of tries to prevent “hacking” into the system.

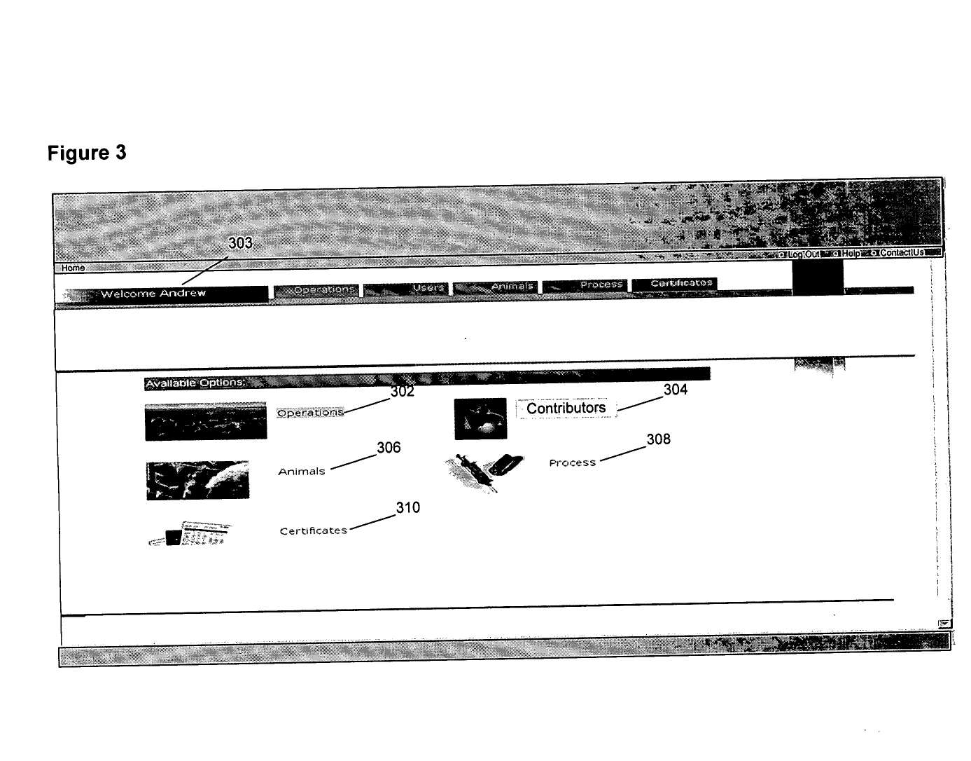

Assuming that the registered contributor is authenticated, and with successful login the contributor 104 gains access to the system. FIG. 3 is a graphical representation of screen display showing a home page of the secure web site according to one embodiment of the present invention. As shown in this figure, the name of the contributor 104 with greeting, representatively shown as item 300 “Welcome Andrew”, appears at the top of the page based on the initial registration information. It is understood, of course, that any other identifier, such as the operation name, for example, may appear instead. Further, the home page includes a menu containing a number of action items links to other web pages—to provide functionality to the web site. These items are “Operations” 302 “Contributors” 304 “Animals” 306 “Process” 308, and “Certificates” 310. Additionally provided on the home and other web pages on this web site are such traditional links as “Home” 312 and “Back” 314 with their functions being universally understood by any contributor of the World Wide Web (www).

FIG. 4 is a graphical representation of screen display when “Operations” items 302 is selected, according to one embodiment of the present invitation. Again, the contributor 104 can be a facilitator, a producer, a farm manager a feedlot operator or any other participant of the livestock industry. As shown in this figure, two action items are preferably displayed one is “View” 402 to view operations for that contributor already in the system and the other is “Add” 404 to add new operation to the system. Upon contributor's selection of the “View” 402 item, the list of operations for that contributor already entered into the database 108 are displayed in table 406 of FIG. 4A. Let it be assumed that the there is another farm to be entered into the database 108. It is important to note that a contributor 104 who is solely a facilitator is allowed to add operations. A user simply cannot add operations. A user, defined above is a cattle producer, feedlot operator, farm manager or other livestock industry participant, expect a facilitator. To this end, the facilitator clicks on “Add Operation” action item 408 to activate another web page as shown in FIG. 4B. Optionally, the facilitator can click the “Add” 404 tab in FIG. 4 to add another operation into the database.

FIG. 4B is a graphical representation of screen display when a facilitator desires to add operations. As an example, as shown in this figure, the facilitator wishes to add an operation “Cows in the Pasture, LTD”. The facilitator enters information into the following fields. “Segment” 410, “Operation Name” 412; “Premises ID” 414; “Operation Address”416A; “Operation Address 2” 416B; “City” 417; “State” 418; “Postal/Zip Code” 420; “Country” 422; “Owner First Name” 424; “Owner Last Name” 426; “Email” 428; and “Phone” 430. Note that the fields with * must be filled in order to add the operation. Furthermore, the “Segment” 410 field has a drop down menu displaying different kinds of operations such as background/stocker, cow/calf, dairy, feedlot, vetenary clinic/dealer etc. The “Segment” 410 field shows what kind of operation is being added. These fields may be representatively populated as shown in FIG. 4B. Thereafter, “Submit” action item 432 of FIG. 4B is activated by the facilitator in order to transfer this information from the web server 106 to the database 108. Alternatively, “Reset” action item 434 may be activated in order to cancel the information in the fields.

FIG. 4C is a graphical representation of screen display after the information on a new operation has been submitted for entry into the database. This figure is an illustration of the updated table 406 containing information on the operations including the newly added operation “Cows in the Pasture LTD”.

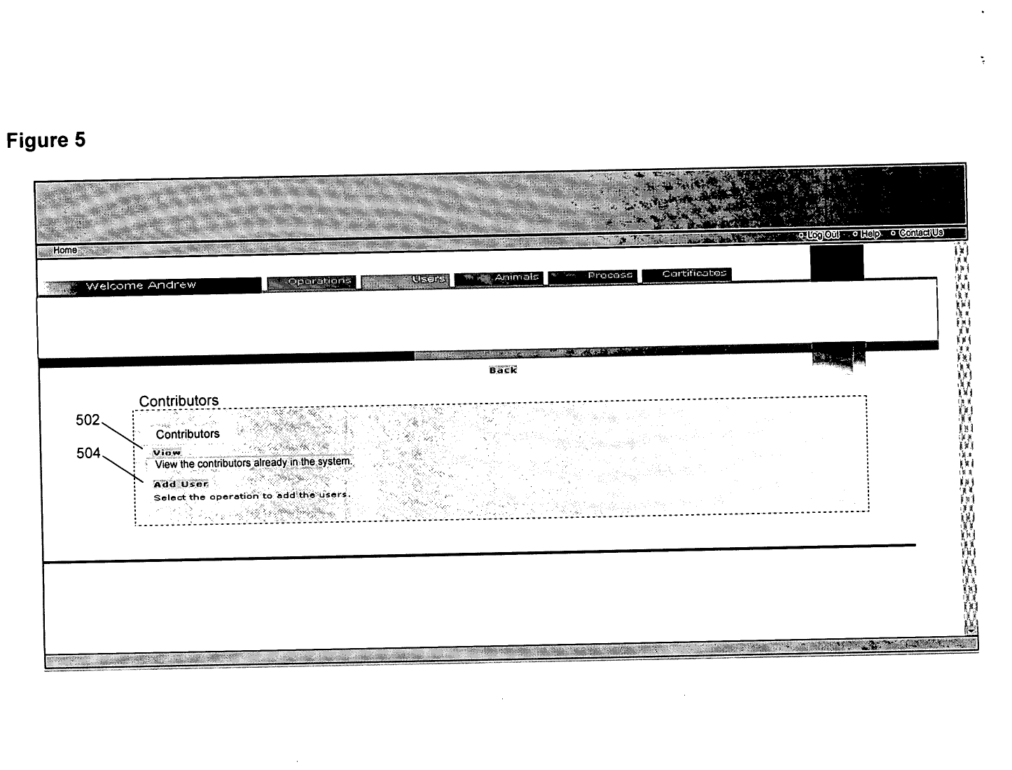

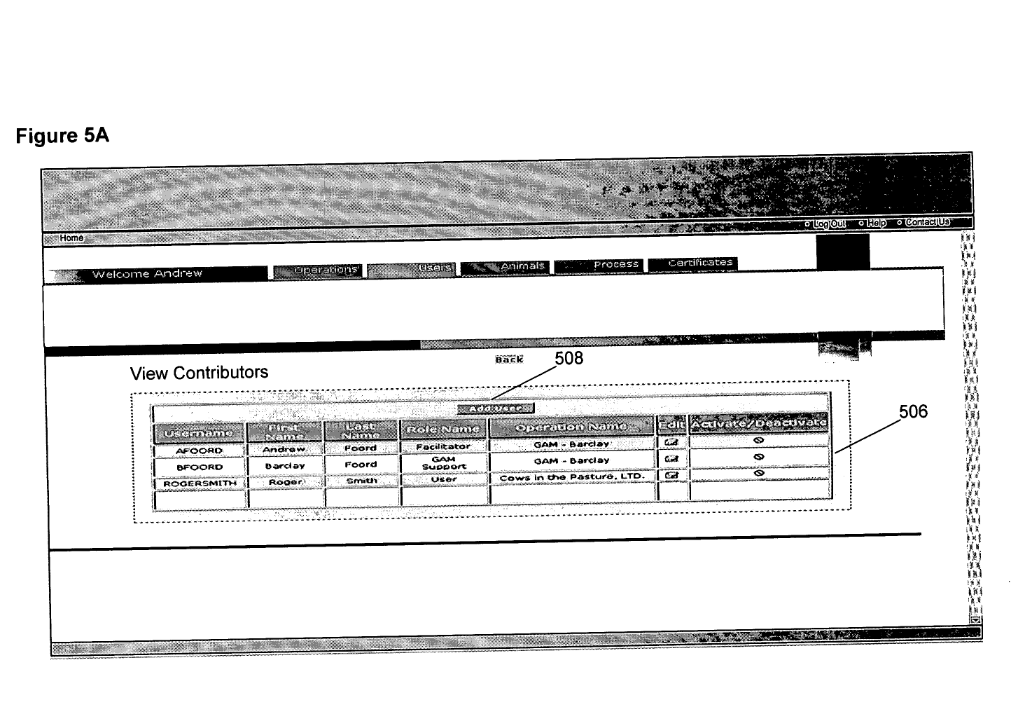

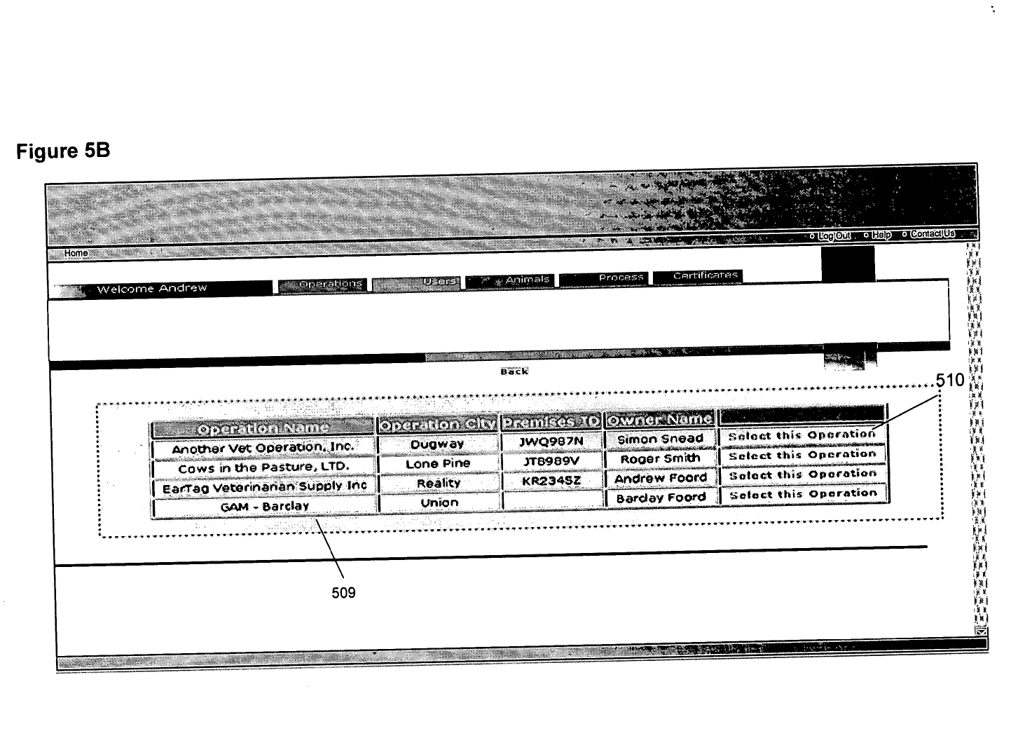

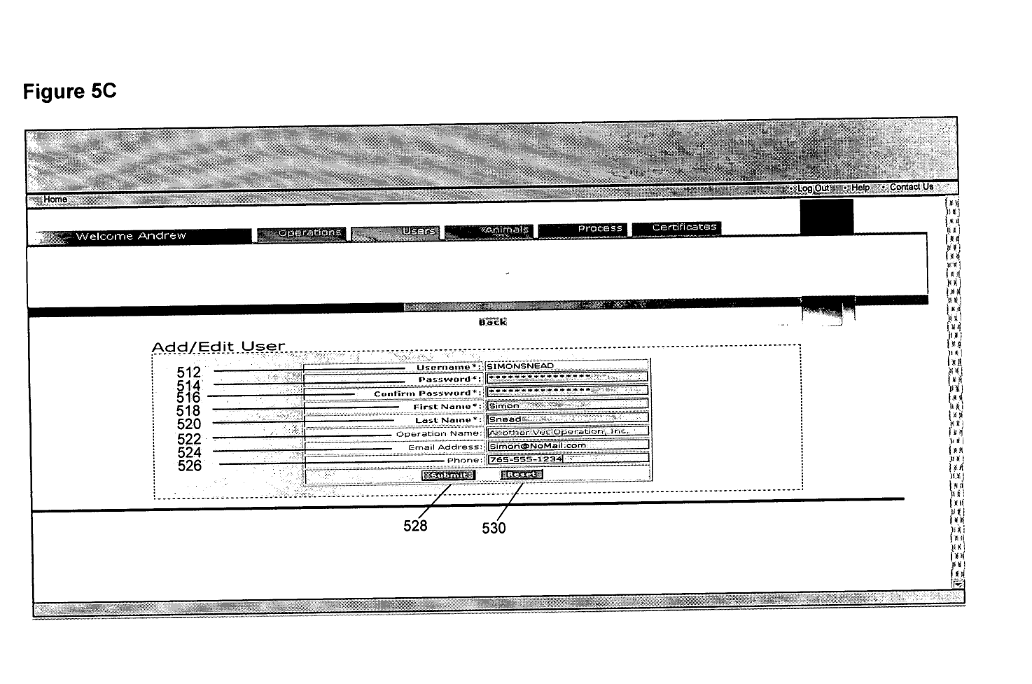

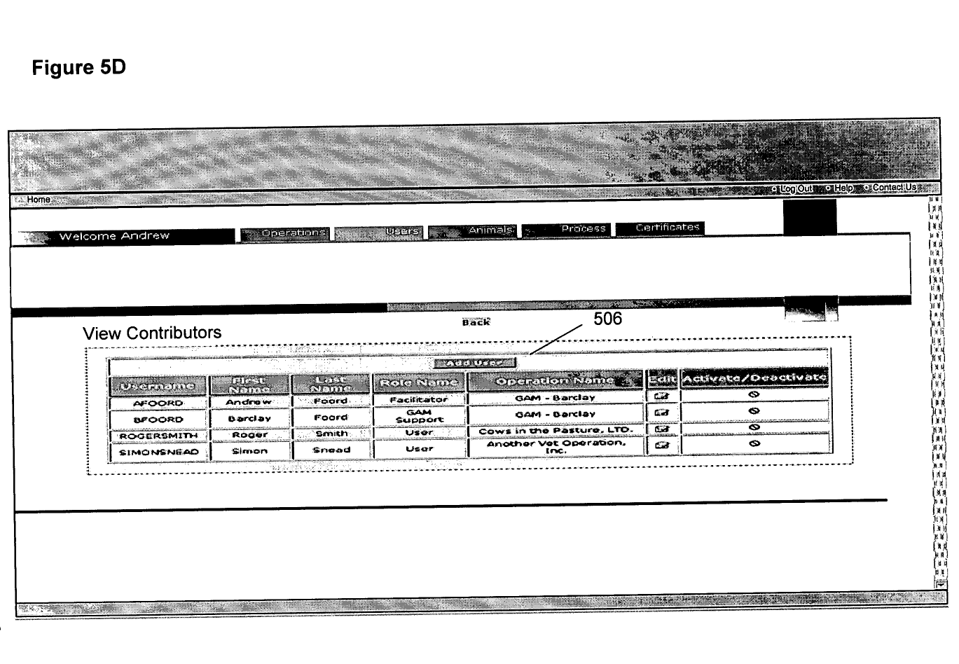

FIG. 5 is a graphical representation of screen display when “Contributor” item 304 is selected on FIG. 3 according to another embodiment of the presentation. As shown in this figure, two action items are preferably displayed. One is “View” 502 to view the contributors already in the system and the other is “Add User” 504 to select the operation to add the user(s) Action item. Upon selection of “View” 502 item, the list of contributors information table 506 is displayed in FIG. 5A, listing all the contributors including their associated information already in the database 108. “Add user” action item 504 allows a contributor 104 who is solely a facilitator, to create new users and preferably control their access within the system. It is important to note that a facilitator can de-activate or activate a user, but a user cannot add new users. Only a facilitator has the authority to add or create a new user. If a contributor 104 who is a facilitator wishes to add another user, that facilitator can select “Add User” action item 508 to activate another web page as shown in FIG. 5B in order to add another user for the operation. Optionally, the contributor can select the “Add User” 504 action item in FIG. 5 to add another user for the operation already in the system. FIG. 5B displays a table 509 listing the names of operations and their pertinent information. In this figure, the facilitator will be asked to select an operation by clicking on “select this operation” action item 510. Upon selection of this item 510, the facilitator will be directed to another web page as shown in FIG. 5C.

FIG. 5C is a graphical representation of screen display when a facilitator desires to create another user. As shown in this Figure, the facilitator enters information into the following fields: “username” 512, “password” 514, “confirm password” 516, “first name”, 518, “last name” 520, “e-mail address” 524, “phone” 526. These fields may be representatively populated as shown in FIG. 5C. Please note that the “Operation Name” 522 field will appear in the background with the operation name selected by the facilitator, which in this example is “Another Vet Operation, Inc.” Note that the fields with the asterisk * must be filled in order to add/edit the user. Thereafter, “submit” action item 528 of FIG. 5C is activated in order to transfer this information from the server 106 into the database 108. Alternatively, “reset” action item 530 maybe activated to cancel the information in the fields.

FIG. 5D is a graphical representation of screen display after the information on a new user has been submitted for entry into the database. This figure is an illustration of the updated table 506 containing information on the contributors including the newly added user, “Simonsmead”.

Referring to FIG. 6, this is illustrated a graphical representation of screen display when “Animals” item 306 item is selected on FIG. 3 according to another embodiment of the present invention. As shown in this Figure, several action items are preferably displayed as options such as “Manage Animals” action item 602, “Add Animal” action item 604, “Upload Animals” action item 606 and “View Upload History” action item 608. “Manage Animals” action item 602 gives the contributor the ability to view, modify or add animals. “Add Animal” action item 604 is the manual entry of animal data to add animals one at a time. “Upload Animals” action item 606 is an automatic entry of the animal data from data illustrated in various formats such as Word, Excel, Access, or other applications. Action item 606 gives the contributor ability to add many animals at a time by uploading. Finally, “View Upload History” action item 608 gives the contributor the ability to view the history of files that the contributor has uploaded in action item 606. Each of the above action items will be described in greater detail herein below.

FIG. 6A is a graphical representation of screen display when a contributor activates “Manage Animals” action item 602 on the web page. This figure is an illustration of table 610 listing information about the operations with an additional field to select an operation. Let it be assumed that the contributor 104 selects the “Cory's Cattle Farm” operation to manage his animals on that farm. Based on the selection of this action item, a web page is presented as shown in FIG. 6B.

FIG. 6B is a graphical representation of screen display where a contributor can view all animals in the “Cory's Cattle Farm” operation as selected by the contributor. As show in this figure, for example, are eight animals for Cory's Cattle Farm that were uploaded. Each animal is shown with animal VID, animal EID and the process linked to the animal. Also contained in the table 612 are “View Age/Process Animal” action item 614, “View Source/Movement Animal” action item 616, “Add Animal” action item 618, “Upload Animals” action item 620 and “Upload Animal History” action item 622. “View Age/Process Animals” action item 614 allows you to select specific or all animals to view age or the process that is identified with the animals. “View Source/Movement Animals” action item 616 allows you to select specific or all animals to view the source or movements of the animals. “Add Animal” action item 618 allows you to add one animal for Age/Process, Source/Movement or both. Action item 618 is a manual entry by the contributor as will be described in detail below. The “Upload animals” action item 620 enables the contributor to upload multiple animals from another application file. The “Upload animal history” action item 622 allows the contributor to view whether the file uploads previously were successful and to what degree. Action item 620 is an automatic entry of animal information from data files stored in such formats as Excel, Access, etc. When such file is uploaded to the server, the information is extracted and then directed to specific fields as will be described in detail below. When activated, action item 622 is operative to populate fields in the similar manner.

Turning to action item 618 in more detail, a web page is transferred from the server 106 to the client as shown in FIG. 6C. Optionally, the contributor can select the “Add Animal” action item 604 in FIG. 6 to manually add an animal to the system. FIG. 6C is a graphical representation of screen display for manually adding animals. As shown, there are three different fields of animals chosen. One is the “Age/Process Animal” field 621, second is “Source/Movement Animal” field 623 and the third is “Both” field 625 which means that the animal can be both Age/Process and Service/Movement animals. Even though as a default the interface for entry of information is for an Age/Process Animal, it is understood that entry could be for Source/Movement Animal or both as will be described in FIG. 6D and FIG. 6E respectively. An Age/Process Animal is one which is being tracked, according to its date of birth, and the history of medical procedures, called “Processes” which were performed on that animal. According to the FIG. 6C, the contributor enters information into the following fields: visual ID (“VID”) 624; electronic ID (“EID”) 626; “Birth Date” 628; “Birth Date Type: 630; “Sex” 632. Note that the “Operation Name” field is already filled in as per contributor's selection in FIG. 6A. All the fields noted in * are required to be filled in with an option to fill either “VID” 624 or “EID” 626. It will be noted that in “Birth Date” field 628, an on-screen calendar is provided to assist the contributor in entering the birth date information. In addition, “Birth Date Type” field 630 can have the values of “actual” or “estimate” animal birth dates, while “Sex” field 632 can have the values “Heifer”, “Bull” “Steer” or “Cow”. Although not shown, these fields may be representatively populated. Thereafter, “Save Animal” action item 634 of FIG. 6C is activated in order to transfer this information to the database 108. Alternatively “Reset” action item 636 may be activated in order to cancel the information in the fields.

If the contributor wishes to manually enter data for a Source/Movement Animal, he/she can select the “Source/Movement Animal” field 623 in FIG. 6C and a web page is transferred from the server 106 to the client as shown in FIG. 6D. FIG. 6D shows the input information for a Source/Movement Animal. Source/Movement Animal is one that is recorded according to its home premises, and the new premises it is moving to, along with the dates of its moves. According to the FIG. 6D, the contributor must enter the “VID” 624 and the “EID” 626 fields similar to those in FIG. 6C. The contributor also must enter additional fields such as “Arrived From/Origin Premises ID” field 634, and/or “Arrived From/Origin Premises ID” field 636, “Source Premises ID” field 638 and/or “Source Premises Name” field 640 (which in this case by default is the operation name), “Arrival date” field 642. Although, not required, the contributor may also wish to enter other fields such as “Destination Premises ID” field 644 and/or “Destination Premises Name” field 646 and “Departure Date” field 648.

If the contributor wishes to manually enter data for both the Age/Process Animal and the Source/Movement Animal, he/she can select the “Both” field 625 in FIG. 6C and a web page is transferred from the serve 106 to the client as shown in FIG. 6E. In FIG. 6E, the fields as shown are combination of those in FIG. 6C and FIG. 6D since both the data of Age/Process Animal and Source/Movement Animal is required with the * shown as required fields. It is to be noted that the required fields in Age/Process Animal, Source/Movement Animal or both are available through mapping upon importing the file from another application. This will be described in greater detail with respect to FIG. 6H.

FIG. 6F is a graphical representation of screen display after the information on a new animal has been manually submitted for entry into the database 108. This figure is an illustration that a new animal has been successfully added to this operation. Since the Animal type is “Both”, this animal is being tracked for both Age/Process and Source/Movement. If the contributor wishes to view all the animals for this operation, he/she can select “View All Animals” action item 650 to view the update table 612 (not shown) listing the information on all the animals including the newly added animal. It will be noted that the “Delete Animals” action item 652 is included in FIG. 6F for each animal entered into the database.

Let it be assumed that a contributor wishes to do an automatic entry of animal information from files stored in other formats. To this end, the contributor can either select the “Upload Animals” action item 620 in FIG. 6B or the “Upload Animals” action item 606 in FIG. 6, which in turn activates a web page as shown in FIG. 6G. In this scenario, the contributor will use a “Browse” field 654 to choose the file to Upload. The file can be either local to the contributor's own computer or preferably available on a shared network drive. After choosing the file, the contributor will select “Proceed to Mapping” action item 656. Upon selection of this action item, a web page is presented to the contributor as shown in FIG. 6H.

FIG. 6H is a graphical representation of screen display indicating the beginning of the upload feature according to another embodiment of the present invention. As shown in this figure, there are three entry window fields, a “source fields” 658, “target fields” 660 and “mapped fields” 662. The “Source Fields” 658, are specified by column headers within a comma delimited (e.g. spreadsheet such as MS EXCEL) file that contains the animal seed data to be uploaded. Contributor in FIG. 6G. The “Target Fields” 660 are a set of fields where the animal seed data is placed within the database. The “Mapped Fields” are the result of the merger of the “Source” Fields with the “Target” fields forming a linking pair, i.e., linking the Source data elements into the Target field in the database. Even though the “Source Fields” 658 in FIG. 6H show many fields, there are only four fields that are required for the upload. Those are a unique ID (identifier) of either electronic (EID) or visual (VID) format, the animal's sex, birth date, and birth data type which is specified as being either actual or estimated. The “Arrow” tabs shown in FIG. 6H actually link or pair the Source fields with the Target fields. It is noted that the “Cancel” tab will cancel any linking between the Source and the Target field. Upon the contributor clicking on the “Continue Process” tab, the data upload tool 107 will upload the animal seed data into the set of target fields to initiate an individualized data set. in the database 108 as shown in FIG. 6I.

FIG. 6I shows a graphical representation of screen display with fields as shown in the “Mapped Fields” 662. It is to be noted that the fields in the “Mapped Fields” are the four required fields, mapped according to their meanings. Also, the language of the fields mapped may be different, but the words pertain to the same data. Again, upon contributor selecting the “Continue Process” tab in FIG. 6I, a web page is presented as shown in FIG. 6J.

FIG. 6J is a loading screen that is displayed to the contributor during the process of extracting from the “Source Field” and loading into the “Target Field”. As indicated in FIG. 6J, a note is displayed to the contributor on how to correct any errors or discrepancies that may occur upon completion of the upload. After the upload is completed, the screen shot of FIG. 6J will close and open up a new screen display illustrating the result of the loading process as shown in FIG. 6K. FIG. 6K shows a table 664 of the resulted loading process with information including as to how many animals records were received from the contributor's selected file and how many of the new animals were added to the database 108. As an example, there is shown that 26 records were received and 24 new animals have been added, clearly indicating that the remaining two animals have errors which prevented them from being loaded. In order to correct these errors, the contributor selects file name “cattle.xls”, (example of the file name selected by contributor) to correct the two incomplete animals. Upon this selection, the contributor is presented with a screen display of Animals Upload History in FIG. 6L. FIG. 6L illustrates a table 666 which shows the two animals that failed to load with an error message indicating the reason for failing to load. In this example the error message is “Invalid Sex”, i.e. the contributor failed to complete the data on the animal's sex. The animals records can be completed by contributors selecting the link below the error message which leads into another screen display shown in FIG. 6M. In FIG. 6M, the contributors can edit the animal data to correct the error(s). In this case, the contributor will fill in the “sex” field by using the drop down box menu which will present a list of choices which will be selected by the contributor. Similarly, the contributor can repeat the correction process by selecting the link below the error message of the next animal in the list which failed to upload and edit the animal data until all the animals are corrected. If many animals are in error, it may be preferred that the contributor remove all the animals which were imported, modify the format of the file and import again.

Upon correction of all the animals, or if the contributor selected file imported without errors, the contributor will be directed to a web screen display of Animals Upload History as shown in FIG. 6N. Optionally, the contributor can select “View Upload History” action item 608 in FIG. 6 to be directed to the screen page of FIG. 6N. This screen display of Animals Upload History illustrates animals have been successfully saved and none were lacking required data, indicating that the number of records required matches the new animals added. It is important to note that a contributor may select the “Upload Animals” action item to load all the animal seed data at once or alternatively the contributor may load one attribute of the animal seed data at a time.

Referring to FIG. 7, there is shown a graphical representation of a screen display when “Process” action item 308 is selected on web page on FIG. 3, as another embodiment of the present invention. As shown in this figure, a contributor is given a few options for processing the animals. The options include “Manage Process” action item 702, “Add Products: action item 704 and “Assign Process to Animals” action item 706. “Manage Process” action item 702 gives contributor the capability to create or modify processes, which is the animal husbandry process as defined above. “Add Products” action item 704 gives user the capability to add products to a process that the contributors have created. “Assign Process to Animals” action item 708 gives contributor the capability to assign a process contributor created to animals. The processes are simply treatment procedures affiliated with an operation as will be described in greater detail below.

Let it be assumed now that the contributor desires to create or modify processes. To this end the contributor selects “Manage Process” action item 702 on FIG. 7. to activate a web page shown in FIG. 7A. FIG. 7A is a graphical representation of a screen displaying a list of available operations for the contributor with their corresponding link “Select this Operation”. The screen display of FIG. 7A allows the setting of process sets to operations. These processes sets are specific to an operation, and cannot be copied from one site to another. However, once they have been set up, the process sets can be used multiple times over the years. Lets assume, for example, the contributor selects “Another Vet Operation Inc.” as an operation, the contributor is then immediately directed to the web page as shown in FIG. 7B. FIG. 7B shows the list of process for “Another Vet Operation Inc.”, which in this case none are found. If there were process listed, the contributor may desire to select “Delete Process” action item 711 to delete any process for that operation. The contributor will desirably select “Add Process” action item 708 which will lead to generate a display of “Regimen Name” 710 field and the “Process Name” 712 field as shown in FIG. 7C. The “Regimen Name” 710 field is preferably automatically filled with the season and the year. The “Process Name” field 712 will be filled by the contributor. As an example shown in FIG. 7C the contributor fills in “Initial Treatment for new stock” in the “Process Name” field and then submits the “Create Process” action item 713 which generates the web screen display as shown in FIG. 7D. The screen display of FIG. 7D indicates that the process has been successfully created. It also lists the process name created for the operation “Another Vet Operation”. The contributor certainly has options to add more processes by selecting “Add Process” tab and/or delete processes by selection the “Delete Process” tab. The contributor can preferably add procedures/products to the process by selecting the link under “Process Name”. Let it be assumed that the contributor selects the process “Initial Treatment for new stock” which activates a web page as shown in FIG. 7E. Optionally the web page 7E can be activated by contributor selecting the “Add Products” action item 704 in FIG. 7.

FIG. 7E is a graphical representation of screen display of Edit “Initial Treatment for new Stock”, upon selection of this process in FIG. 7D. The screen display of FIG. 7E shows the ability of the system to assign procedures and products to a stored process set, associated with an operation. The screen display in FIG. 7E includes two key actions items, “Add Company A Procedures/Products” action item 714 and “Add Other Procedures/Products” action item 716. Company A Procedures/Products are preferably procedures/products belonging to a specific company such as Schering Plough. The list of procedures/products of Company A including the brand name are preferably already stored in the database 108 by an administrator. Other Procedure/Products are preferably those belonging to other companies and the list of procedure/products including the brand names can be prestored in the database 108 or preferably added in the fields by the contributor. Upon Contributor's selection of “Add Company A Procedural Products” action item 713, a screen display FIG. 7F is generated. FIG. 7 displays drop down menu buttons under the “Procedure/Products” column and the “Brand Name” column for contributor to select the procedure/product to be applied to the animal along with the brand names of the medicines and/or vitamins associated with each of the procedure/product. The “Lot #” column field is normally entered by the contributor. It is to be noted that each procedure/product is added to the process one line at a time. Upon completion of the entry of the procedures/products, brand name and lot #, the contributor will submit the “save Process” action item 714 which generates a web page display of FIG. 7G which indicates that the products have been successfully added or updated for the contributor selected process of “Initial Treatment for new Stock.” Note that the “Uncheck All” column is checked as a default for all procedures/products so they are not deleted from the process.

Upon completion of all procedure/products, the contributor may preferably return to the screen display of FIG. 7 and select the “Assign Process to Animals” action item 706. Upon contributor's selection of this action item, a web page is activated as shown in FIG. 7H. FIG. 7H is a graphical representation of screen display of a table 715, listing all the animals added by the contributor. This screen display gives the contributor capability of assigning a process to a selected group of animals at a premise. The contributor is given clear instructions in the instruction box 716 on how to assign the animals using the “Assign Process” action item 718. The contributor also has an option to delete any processes he/she wishes by choosing the “Delete Process” action item 719. So, animals are selected by checking the check box under “Check All” column. Then, the contributor will select “Assign Process” action item 718 in FIG. 7H which will generate another web page as shown in FIG. 7I. FIG. 7I is similar to FIG. 7H with an addition of a box 720 listing the choices of process name to assign to the checked animals, which are the selected animals. This listing can be seen by the drop down menu button as shown. The contributor will then select the process to assign to the checked animals and submit “Assign this Process” action item 722. Upon contributor's selection of this item 722 another web screen page is displayed on FIG. 7J. Note that the table now 715 now includes the processes assigned to the checked animals. The table 715 illustrates how process sets are associated with the animals. Even though the table 715 shows one process assigned to each animal, it is to be noted that multiple processes can be assigned to an animal. Again, a process set can be removed by selecting the “Delete Process” tab. Also if one process set needed to be removed, that row entry for the animal's records can be individually deleted. It is important to note that a contributor may add all the animal husbandry processes for the animal at one time or alternatively may input one animal husbandry process at a time.

Lets assume for example, the contributor selects the operation “Milking Time Inc.”. Upon this selection, the contributor is directed to the web page shown in FIG. 7K which shows the list of available processes that the Operation “Milking Time, Inc.” has established. In this case, “Milking Time, Inc. has two process sets, the “Milker” and “Halloween” process sets. These already established processes can be assigned to the animals in similar method as described above. Generally, different processes are related to different locations such as ranches, processing plants, feedlots etc. Other advantages are that you are able to plan a treatment day and so the same process is not repeated (ex. same medication is not applied).

Referring to FIG. 8, there is shown a graphical representation of screen display when “Certificates” 210 tab is selected on web page of FIG. 3 as a further embodiment of the present invention. According to this Figure, the contributor is presented with three choices: “New Certificate” action item 802 to create new certificate, “View Incomplete Certificates” action item 804 and “View Completed Certificates” action item 806. Certificates are the verification documents to be attested by the Cattle's Owner and his Facilitator, who is usually a Veterinarian as will be described in greater detail below.

FIG. 8A is a graphical representation of screen display upon contributor's selection of “View Incomplete Certificates” action item 804 in FIG. 8. FIG. 8A includes a table 803 listing the certificates that are incomplete and are available for editing and deleting. Notice the “Certificate Name” is a facilitator-generated label for the document and is very useful for the facilitator creating many certificates for the same operation as will be described in greater detail below. Upon user's selection of “View Completed Certificates” action item located above the table 803 in FIG. 8A, the contributor is directed to another screen display as shown in FIG. 8B. Alternatively, the contributor can activate the web page of screen display of FIG. 8B by selecting the “View Completed Certificates” action item 806 in FIG. 8. FIG. 8B includes a table 805 listing the certificates that are complete and finalized for issuance. Also, the contributor may preferably select the “View Incomplete Certificates” action item 807 above the table 805 in FIG. 8B to be directed to the display of FIG. 8A.

Let it be assumed that a new certificate needs to be created. Note, that only the contributor 104 who is solely a facilitator can create new certificates. A contributor 104 who is a user cannot create new certificates. The facilitator selects the “New Certificate” action item 802 in FIG. 8, such that a web page appears as shown in FIG. 8C. FIG. 8C is a graphical screen display of four different types of Certificates that can be created; Age/Process Group Certificate 808, Age/Process Individual Animal Certificate 810, Source/Movement Group Certificate 812, Source/Movement Individual Animal Certificate 814. Let's assume, for example that the facilitator chooses to create the Age/Process Group Certificate 808 which activates the web page as shown in FIG. 8D. FIG. 8D displays a table 816 listing operations associated with that facilitator. Once the facilitator has requested for a certificate, it is automatically reserved a number, for example “103624” as shown in FIG. 8D. This number will not be assigned again, even if this certificate is deleted. As shown in this figure, progress triangles 817A-817D, displayed above the table 816 show pathway with each containing the stored information. In this screen display, the operating triangle is highlighted due to selection of the operation.

In the first stage of certificate issuance, an operation is selected from table 816. Once the facilitator selects a particular operation, a web page is presented on the facilitator's operation as shown in FIG. 8E. FIG. 8E is a graphical representation of screen display when “Select this Operation” is chosen in FIG. 8D. As an example, Another Vet Operation, Inc. is chosen by the facilitator as shown in FIG. 8D. More specifically, the operation information with all the fields, as previously populated by the facilitator, is provided for review and confirmation. It is important to note that Certificate number 103625 has already been assigned and reserved in the system. All the fields are filled except the “Certificate Name” which is to be filled by the facilitator. The certificate should be desirably named with a recognizable label, for example, “150 Spring 2006 steers”. Two action items, “Next Screen”, 818 and “Reset” 820 are displayed for facilitator's activation. Assuming that the information, as previously entered into the database is correct, and “Next Screen” 818 is activated, information on all animals entered for that particular operation is presented in a tabular form as shown in FIG. 8F.

FIG. 8F is a graphical representation of screen display at a second stage of certificate issuance. The second stage includes choosing animal(s) to be added to the Certificate. According to this Figure, table 820 contains a list of animals to be added to the certificate. Above the table 820 includes “Add Animals” action item 822 to add the animals in the table. Also included is “Upload Animals” 824 action item to upload the required data for the animals. Also included are boxes 826 for the facilitator to place a check mark in the boxes 826 for choosing the animal. If all the animals in the table 820 are chosen, the facilitator can either check all boxes 826 or activate “Select All Animals” action 828 as shown. Optionally, the facilitator can also preferably activate “De-Select All Animals” action item 830 to erase the check marks on the boxes 822. It will be noted that the progress triangles moved to the second stage, thereby highlighting the Animals Triangle 817 B. Even though for illustration purposes the table 820 lists six animals with three selected, it is to be noted that many more or fewer animals may be listed in the table 820. If an animal is not available, the “Manage Animals” action item 832 allows you to modify animals to update required fields for this type of certificate. If the animals, the facilitator is looking for have incomplete data, they will preferably be displayed on the table 820 as “grayed” out indicating they lack information. Alternatively the animals could be “grayed” out because they also have been placed on another Certificate of the same type, such as Age/Process or Source/Movement, which would make them unavailable for addition to another similar certificate.

FIG. 8G is a graphical representation of screen display at the third stage of certificate issuance which is shown by the Procedures triangle 817 C highlighted in the Progress triangle. The third stage includes various animal procedures/products and other health related information for that animal in the list in table 834. The list is compiled from processes included in procedure sets associate with an operation. Processes can be pre-loaded with their inclusion from the procedure sets associated with an operation as discussed above with reference to FIG. 7. Alternatively, they can also be loaded individually at this screen display of FIG. 8G with the “Add Company A Procedures/Products” action item 836 and “Add Other Products” action item 838. At this point, the Lot #s on Brand Name Products of other procedures/products is required if they were not placed initially during the assigning of the procedures/products to the process. It is to be noted that any data in this display of procedures in FIG. 8G can be edited by simply clicking the drop-down menus as shown. Furthermore, by selecting the “Add Processes” action item 840, a facilitator can preferably choose to include additional processes during this third stage of certificate issuance. Upon facilitator completion of the procedure stage, the facilitator moves to the fourth and final stage of certificate issuance via “Next Screen” action item 842. In response, a web page is transmitted from the server to the client as shown in FIG. 8H.

FIG. 8H is a graphical representation of screen display at a fourth stage of certificate issuance. According to this figure, a facilitator may preview a certificate for the selected group of animals. Since this certificate is in a preview mode, it gives facilitator a final opportunity to review all the information on the certificate. Notice that Procedures without brand names do not require lot #s. Upon facilitator's preview of the certificate, he/she may select the following actions: “Save & Finish Certificate Later” 844, “Edit” 846, and “Finish the Certificate” 848. The action item 844 is used when further health-related procedures or products will be administered to the animal. The action item 846 is to modify and/or delete any information on the certificate, and the action item 848 is to issue the certificate for the selected animal(s).

Let it be assumed that the facilitator selects “Save & Finish the Certificate Later” action item 844 which directs the facilitator back to FIG. 8. Here the contributor may preferably select “View Incomplete Certificates” action item 804 which will activate the web page shown in FIG. 8I. Note the certificate #103625 with the name “Selling Certificate” which was just produced in FIG. 8H is now listed in table 803. This table 803 has been updated since last seen in FIG. 8A. At this point the certificate #103625 is an incomplete certificate and is available for editing and deleting. If this certificate is deleted, the animals listed on it will become available to be placed on a similar Age/Process Certificate. Once finalized, a certificate cannot be modified and the animal described on that Certificate will no longer be available to choose for another certificate of the same type.

FIG. 8J is a graphical representation of an example of a certificate preview of a Source/Movement Certificate created for an individual animal. Note that this type of certificate requires locations and dates of moving between premises, as well as tracking of individual Animal ID's such as VID (visual) or EID (electronic) and date of birth. Procedures are not recorded with the movement Certificate. Also, if an animal is needed to track for both process and movement, it can be placed on two different Certificates, an Age/Process Certificate and a Source/Movement Certificate. Also shown in FIG. 8J are three action items; “Save & Finish the Certificate Later” action item 846 which allows the facilitator to save the certificate which will display on the view of “Incomplete Certificates”, “Edit” action item 848 will allow the user to modify or delete the certificate and “Finish the Certificate” action item 850 will finalize and complete the certificate.

FIG. 8K is a graphical representation of screen display of the second stage of creating a new source/movement certificate for a group of animals, i.e. group movement certificate. Note that the facilitator was able to skip the first stage of selecting an operation since the operation name is the Another Vet Operation, Inc. which is the same as the one selected by the facilitator when creating a process Certificate 103625. Note in preparation of the group movement certificate as shown in FIG. 8K, the individual animals' ID numbers are not used. Instead, fields describe the lot of Cattle and their range of birth dates. The range of birth dates is a required field which is highlighted with an asterisk*. Similar to the Individual Animal Movement Certificate, the other required fields pertain to the group of Animals' movement, with the dates of the transport, also highlighted with an asterisk*, as shown in FIG. 8K. Upon facilitator selection of the “Next Screen” action item, the server 106 transfers the web page to the client with a screen display of Certificate Preview as shown in FIG. 8L.

FIG. 8L is a graphical representation of a group movement certificate in a preview mode for a group of animals. Note that this type of Certificate includes a range of birth dates and group movement information such as origin premises ID/Name and destination premises ID/Name. Also, included are animal and departure date in a range since for a large group of cattle, this allows transport span a number of dates. The action item “Save & Finish the Certificate Later” 852 is used when further health-related procedures or products will be administered to the animal. The action item “Edit” 854 is to change any information if incorrect, and the action item “Finish the Certificate” 856 is to issue the certificate for the selected animal. If the action item “Finish the Certificate” 856 is selected, the facilitator is presented with a warning that indicates once the certificate is issued, it cannot be modified or deleted, and all information on the animals is removed from all the tables under “Manage Operations” and “Manage Animals” items.

FIG. 8M is graphical representation of screen display of the group animal process certificate in final form. As shown in this figure, the certificate holder can view it in PDF format or e-mail it to the potential buyer, in accordance with action items, “View Certificate in PDF/Adobe Reader” 858 and “E-mail Certificate” 860, respectively. Furthermore, the verification section of the certificate requires execution by the owner/manager of the operation and witness/verifier, typically a veterinarian, who is independent of the animal ownership. Preferably, electronic signatures are requested on the certificate; however, the certificate can also be printed our and signed/dated in a conventional manner. Once, the veterinarian executes the certificate, the certificate provides assurance of the verification of the data for the animal(s).

FIG. 9 is a process flow chart for storing and managing livestock data in accordance with one embodiment of the present invention. After “Start” 900, a decision is made whether a login procedure is initiated shown in block 902. If successful, it is determined whether operations are to be selected in block 904. If the answer is affirmative, such functions as view operations, add operations are performed with respect to the operation selected in block 906. Another decision is then made whether the contributors are selected in block 908. If the answer is affirmative, such functions as view contributors, add users, view are performed with respect to the contributor(s) selected in block 910. Another decision is then made whether animals are selected in block 912. If so, then functions such as manage animals, add animals manually, upload animals, or view animal upload history are performed in block 914. In block 916, it is determined whether a process is selected. If so, then functions such as manage process, add products, assign process to animals are performed in block 918. In block 920 it is determined whether a certificate is selected. If so, then functions such as create new certificate, view incomplete certificates, view completed certificates are performed. A decision is made in block 924 whether the user requests a logout. If so, “Stop” 926 is entered; otherwise, the process returns to block 904.

Although, the present invention as described in FIG. 1-9 follow a sequence of selecting and performing functions on operations, contributors, animals, process, certificates respectively, it is understood, that any sequence may preferably be followed by the contributor according to his/her requirements.

The above description of the process flowchart of FIG. 9 and FIGS. 1-8 refer to various operations, such as select, determine, enter, populate, authenticate, etc. It is understood, of course, that those and other operations are performed by one or more programmable processors/controllers and in the PCs executing appropriate program code stored on a computer-readable storage medium. A microprocessor-accessible storage medium such as computer memory, compact disk (CD), video cassette, digital video disk (DVD), Digital Audio Tape (DAT), etc. In this case, the entire program code and database information are stored on the storage medium that can be accessed by a microprocessor, programmable controller, or any other programmable device. As known to those skilled in the art, a programmable processor/controller retrieves the code, transfers the retrieved code to it internal memory and executes it from the internal memory. In response to the executed code, the appropriate actions take place to carry out the above-described and other functions of the system.

It will be appreciated that while in the above-described preferred embodiment a facilitator reviews and certifies, via a signature for example, that the information in a certificate is true and accurate to the best of his or her knowledge, other people who are independent of animal ownership may carry out this function. They may include any contributor who does not have an ownership interest in either the animals(s) or animal farm/operation, and preferably, is also not an employee of the animal owner or animal farm/operation.

It will be further appreciated that while in the above-described preferred embodiment a certificate is signed via an electronic signature using the first and last names of the signer, an electronic comprises other forms of acknowledgment. That is, in accordance with other embodiments of the present invention an electronic signature may comprise an electronic sound, symbol, or process attached to or logically associated with a certificate and executed or adopted by a contributor with the intent to sign the certificate.

While the present invention has been described and illustrated in connection with the above embodiments, many variations and modifications, as will be evident in those skilled in the are, may be made without departing from the spirit and scope of the present invention. The embodiments of the present invention are thus not to be limited to the precise details of methodology or construction set forth above, as such variations and modifications are intended to be included within the scope of the present invention.

What is claimed is:

1. A method for one or more contributors to generate an individualized data set for an animal in a network environment, said method comprising:
(a) uploading seed data for the animal employing a data upload tool to place the seed data into a set of target fields of a database to initiate an individualized data set for the animal in the network environment; wherein said database comprises the set of target fields; and
(b) inputting an animal husbandry process for said animal into the database; wherein said animal husbandry process is added to the individualized data set initiated for the animal in the network environment; wherein the individualized data set for said animal is generated in the network environment.

2. The method of claim 1 further comprising:
(c) displaying the generated individualized data set for said animal for verification;
(d) verifying the displayed individualized data set by a contributor independent of animal ownership; and
(e) issuing a certificate that comprises the verified individualized data set and a signature field such that, when said signature field is signed, said certificate provides assurance of the verification of said individualized data for said animal.

3. The method of claim 1, further comprising adding procedures and products to the animal husbandry process for the animal.

4. The method of claim 1 wherein the uploading step further comprises linking the animal seed data from another application program into the set of target fields in the database.

5. A system for generating an individualized data set for an animal in a network environment comprising:
(a) a storage medium for storing an individualized animal data set in a database;
(b) a data upload tool to place a seed data into specific target fields of the database and initiate the individualized animal data set; and
(c) a processor programmed to execute code which is operative to upload the seed data for the animal employing the data upload tool to place the seed data into a set of the specific target fields of the database to initiate an individualized data set in the network environment, and to allow input of animal husbandry processes for said animal into the database, wherein said animal husbandry processes are added to the initiated individualized data set for the animal in the network environment; and wherein the individualized data set for said animal is generated in the network environment.

6. The system of claim 5 wherein the processor is further programmed to execute a code which is operative to display the generated individualized data set for said animal for verification, and upon verification of the displayed individualized data set by a contributor independent of animal ownership, issue a certificate that comprises the verified individualized data set and a signature field such that, when said signature field is signed, said certificate provides assurance of the verification of said individualized data for said animal.

7. The system of claim 5 wherein the data upload tool is stored in a server.

8. The system of 7 wherein the server hosts a web site.

9. The system of claim 5 wherein a contributor accesses communication with the server.

10. The system of claim 5 wherein said animal seed data is uploaded from another application program.

11. A method for one or more contributors to provide a certificate for animal data in a network environment, comprising:
(a) uploading seed data for an animal employing a data upload tool to place the seed data into a set of target fields of a database to initiate an individualized data set for the animal in the network environment, wherein said database comprises the set of target fields;
(b) inputting an animal husbandry process for said animal into the database; wherein said animal husbandry process is added to the initiated individualized data set for the animal in the network environment, wherein the individualized data set for said animal is generated in a network environment;
(c) displaying the generated individualized data set for said animal for verification;
(d) verifying the displayed individualized data by the contributor independent of animal ownership; and
(e) issuing a certificate that comprises the verified individualized data and a signature field such that, when said signature field is signed, said certificate provides assurance of the verification of said individualized data for said animal.

12. The method of claim 11 further comprising assigning the issued certificates to the respective animal ownership.

13. The method of claim 11 further comprising forwarding the issued certificate to an interested party.

14. A method for generating an individualized data set for an animal in a network environment, said method comprising:
(a) receiving seed data for the animal;
(b) providing a data upload tool to load said animal seed data into a set of target fields of a database to initiate an individualized data set for the animal in the network environment;
wherein said database comprises the set of target fields; and
(c) linking an animal husbandry process for said animal to the individualized data set initiated for the animal in the network environment; wherein the individualized data set for said animal is generated in the network environment.

15. The method of claim 14 wherein the target fields comprises a set of fields where the animal seed data is placed within the database.

16. The method of claim 14 further comprising linking the animal seed data to the set of target fields in the database.
